(19) United States
(12) Patent Application Publication
(10) Pub. No.: US 2025/0291621 A1
(43) Pub. Date: Sep. 18, 2025

(54) OBSERVING AND GOVERNING ONGOING USE OF INFRASTRUCTURE RESOURCES WHEN RUNNING SELF-SERVICE KUBERNETES WORKLOADS

(71) Applicant: Nutanix, Inc., San Jose, CA (US)

(72) Inventors: Heiko Koehler, Shoreline, WA (US); Prakash Narayanasamy, Saratoga, CA (US); Ramya Arkalgud Prabhakar, San Ramon, CA (US); Deepak Dilip Muley, Campbell, CA (US); Pranav Desai, San Ramon, CA (US)

(73) Assignee: Nutanix, Inc., San Jose, CA (US)

(21) Appl. No.: 19/079,361

(22) Filed: Mar. 13, 2025

Related U.S. Application Data
(63) Continuation-in-part of application No. 18/819,997, filed on Aug. 29, 2024.
(60) Provisional application No. 63/566,128, filed on Mar. 15, 2024.
(60) Provisional application No. 63/566,114, filed on Mar. 15, 2024.

(51) Int. Cl. G06F 9/455; G06F 8/60; G06F 9/50

(52) U.S. Cl. CPC G06F 9/45558; G06F 8/60; G06F 9/5005; G06F 2009/45591; G06F 2209/5011

(57) ABSTRACT

Techniques for maintaining a Kubernetes cluster on a computing infrastructure that supports a given data management application. After deploying a Kubernetes cluster-based configuration of a desired state of the data management application, gathering observations of one or more changes pertaining to influencing and/or maintaining the desired state of that data management application, wherein the one or more changes comprise any one or more of, a change to a policy, a new command to the data management application, a change to the data management application itself, or a change to one or more governance rules or regulations. In response to analysis of the one or more changes pertaining to the desired state of the data management application, synthesizing a new desired state so as to determine a set of changes to be made to either the Kubernetes cluster, or to the data management application, or to the computing infrastructure.

### RELATED APPLICATIONS

The present application is a continuation-in-part of, and claims the benefit of priority to, U.S. patent application Ser. No. 18/819,997 titled “ZERO-CODE ADMINISTRATION OF DATA MANAGEMENT FOR CONTAINERIZED WORKLOADS”, filed on Aug. 29, 2024, which claims the benefit of priority to U.S. Provisional Patent Application Ser. No. 63/566,128 titled “ZERO-CODE ADMINISTRATION OF STATEFUL CONTAINERIZED DATA MANAGEMENT WORKLOADS”, filed on Mar. 15, 2024; and U.S. Provisional Patent Application Ser. No. 63/566,114 titled “OBSERVING AND GOVERNING USE OF INFRASTRUCTURE RESOURCES WHEN RUNNING SELF-SERVICE KUBERNETES WORKLOADS” filed on Mar. 15, 2024, all of which are hereby incorporated by reference in their entirety.

### TECHNICAL FIELD

This disclosure relates to containerized applications, and more particularly to techniques for observing and governing the use of infrastructure resources when running self-service Kubernetes workloads.

### BACKGROUND

In recent years, containerized computing has witnessed rapid adoption. Containers (e.g., self-contained executable units) encapsulate all the necessary code resources to initiate execution on a target infrastructure. Beyond just applications, containers can include operating system components (often referred to as dependencies) and drivers required for running on specific infrastructure.

This so-called containerized paradigm benefits computing infrastructure managers significantly. They can deploy a computing system with a convenient host operating system (like Linux) and subsequently launch multiple executable containers—each potentially native to different guest operating systems. Exploitation of this paradigm lies in the OS-agnostic nature of containers. Infrastructure managers no longer need to worry about porting applications to specific operating systems; instead, they can leverage the flexibility offered by these self-contained units.

As container adoption has surged, higher-level constructs have emerged. Today, interconnected containerized applications, such as may be deployed as Kubernetes “Pods,” form the building blocks of larger applications. Administrators can configure these interconnected components through user-friendly interfaces like the Kubernetes dashboard. Furthermore, the concept of a Kubernetes cluster provides a cohesive framework for managing and orchestrating these containerized workloads such that today, Kubernetes cluster dashboards and other administrator-directed management tools empower administrators to efficiently deploy, monitor, and scale containerized applications, fostering agility and flexibility in modern computing environments.

At the same time that containerized application deployment has exploded in scope and complexity—in particular Docker—and Kubernetes-based deployments—so has the scope and complexity of the containerized workloads and applications that are to be managed by administrators on an ongoing basis. In fact, the scope and complexity of the applications that are to be managed by administrators has exploded to the point that it is no longer feasible for administrators to manage ongoing operation of certain deployments manually. This is true in spite of various advances that the open source community brings to Kubernetes deployments. The aforementioned explosion of scope and complexity of the applications has gone far beyond a mere burden on the administrator to become utterly untenable to expect a human administrator to deal with this explosion. This situation of the explosion of scope and complexity of the applications is exacerbated by the fact that there has been a concurrent explosion in the scope and complexity and ongoing governance demands for the applications.

Unfortunately, the scope and complexity of the containerized applications, and more particularly, the nature of ongoing management issues that are to be managed by administrators (e.g., policy synthesis, policy realization, ongoing policy enforcement, and ongoing application governance), has also exploded to the point that it is no longer feasible for administrators to manage containerized application deployments manually; neither in the context of bring-up, nor in the context of ongoing deployment management. In particular, the activities (and corresponding attendant technical problems) that underlie maintaining containerized applications on an ongoing basis so as to ensure the application stays within (1) the bounds of policy limitations, and (2) in observance of applicable governance rules and regulations, cannot be overlooked. What is needed is a way to reduce or eliminate the burden on human administrators who are tasked with ongoing management of highly complicated containerized applications that run in/on Kubernetes (or in/on other containerized application orchestration systems).

The problem to be solved is therefore rooted in various technological limitations of legacy approaches. Improved technologies are needed. In particular, improved technologies and methods of application are needed to address the aforementioned technological limitations of legacy approaches.

### SUMMARY

This summary is provided to introduce a selection of concepts that are further described elsewhere in the written description and in the figures. This summary is not intended to identify key features or essential features of the claimed subject matter, nor is it intended to limit the scope of the claimed subject matter. Moreover, the individual embodiments of this disclosure each have several innovative aspects, no single one of which is solely responsible for any particular desirable attribute or end result.

The present disclosure describes techniques used in systems, methods, and computer program products for observing and governing the use of infrastructure resources when running self-service Kubernetes workloads, which techniques advance the relevant technologies to address technological issues with legacy approaches. More specifically, the present disclosure describes techniques used in systems, methods, and in computer program products for observing and governing the use of infrastructure resources when running self-service Kubernetes workloads. Certain embodiments are directed to technological solutions for automatically generating executable modules that observe and govern the use of infrastructure resources when running self-service Kubernetes workloads.

As used herein, a module can be implemented using any mix of any portions of memory and any extent of hard-wired circuitry including hard-wired circuitry embodied as a data processor. Some embodiments of a module include one or more special-purpose hardware components (e.g., power control, logic, sensors, transducers, etc.).

The disclosed embodiments modify and improve beyond legacy approaches. In particular, the herein-disclosed techniques provide technical solutions that address the technical problems attendant to maintaining containerized applications on an ongoing basis while staying within the bounds of policy limitations, and while still observing applicable governance rules and regulations, have become impractically burdensome for administrators of containerized data management applications. Such technical solutions involve specific implementations (e.g., data organization, data communication paths, module-to-module interrelationships, etc.) that relate to the software arts for improving computer functionality. Various applications of the herein-disclosed improvements in computer functionality serve to reduce demand for computer memory, reduce demand for computer processing power, reduce network bandwidth usage, and reduce demand for intercomponent communication.

For example, when performing computer operations that address the various technical problems underlying maintaining containerized applications on an ongoing basis while staying within the bounds of policy limitations while in observance of applicable governance rules and regulations, it has become impractically burdensome for administrators of containerized data management applications to maintain the containerized applications with respect to memory usage, CPU cycles demanded, and so on. Strictly as one case, the various data structures and usage techniques as disclosed herein serve to reduce both memory usage and CPU cycles demanded as compared to alternative approaches. Moreover, information that is received during operation of the embodiments is transformed by the processes that store data into and retrieve data from the aforementioned data structures.

The ordered combination of steps of the embodiments serve in the context of practical applications that perform steps for automatically generating executable modules that observe and govern the use of infrastructure resources when running self-service Kubernetes workloads. As such, techniques for automatically generating executable modules that observe and govern the use of infrastructure resources when running self-service Kubernetes workloads overcome long-standing yet heretofore unsolved technological problems associated with maintaining containerized applications on an ongoing basis while staying within the bounds of policy limitations, and while in observance of applicable governance rules and regulations. These problems arise in the realm of computer systems and the solutions thereto are also in the realm of computer systems.

Many of the herein-disclosed embodiments for automatically generating executable modules that observe and govern the use of infrastructure resources when running self-service Kubernetes workloads are technological solutions pertaining to technological problems that arise in the hardware and software arts that underlie Kubernetes (or other containerized application regimes) clusters. Aspects of the present disclosure achieve performance and other improvements in peripheral technical fields including, but not limited to, high performance computing and computing cluster management.

Some embodiments include a sequence of instructions that are stored on a non-transitory computer readable medium. Such a sequence of instructions, when stored in memory and executed by one or more processors, causes the one or more processors to perform a set of acts for automatically generating executable modules that observe and govern the use of infrastructure resources when running self-service Kubernetes workloads.

Some embodiments include the aforementioned sequence of instructions that are stored in a memory, which memory is interfaced to one or more processors such that the one or more processors can execute the sequence of instructions to cause the one or more processors to implement acts for automatically generating executable modules that observe and govern the use of infrastructure resources when running self-service Kubernetes workloads.

In various embodiments, any combination of any of the above can be organized to perform any variation of acts for observing and governing the use of infrastructure resources when running self-service Kubernetes workloads, and many such combinations of aspects of the above elements are contemplated.

Further details of aspects, objectives and advantages of the technological embodiments are described herein and in the figures and claims.

### BRIEF DESCRIPTION OF THE DRAWINGS

The drawings described below are for illustration purposes only. The drawings are not intended to limit the scope of the present disclosure.

FIG. 1A1 exemplifies a system for ongoing administration of a data management workload using zero-code administration techniques, according to an embodiment.

FIG. 1A2 shows an example partitioning of a system that implements zero-code on-going administration of containerized data management workloads, according to an embodiment.

FIG. 1A3 exemplifies an alternative container orchestration system that implements zero-code administration of containerized data management workloads, according to an embodiment.

FIG. 1A4 exemplifies the differences between the operational domain of an application manager as compared to the operational domain of an infrastructure administrator, according to an embodiment.

FIG. 1A5 exemplifies the differences between intent domain semantics as compared to a low level operations domain, according to an embodiment.

FIG. 1B pertains to merely some possible embodiments and/or ways to implement a declarative, no-code, application-level configuration management regime, according to an embodiment.

FIG. 1C1 shows a first agent-enabled Kubernetes cluster configuration technique that is used in systems that implement zero-code administration of data management for containerized workloads. according to an embodiment.

FIG. 1C2 shows an agent-enabled Kubernetes cluster maintenance technique that is used in systems that implement zero-code administration of data management for containerized workloads, according to an embodiment.

FIG. 2A shows a technique to implement zero-code administration of data management for containerized workloads.

FIG. 2B shows various deployment scenario setup considerations that are profiled for use in systems that implement zero-code administration of data management for containerized workloads, according to an embodiment.

FIG. 3 shows an automated policy admission technique as used in systems that implement zero-code administration of containerized data management workloads, according to an embodiment.

FIG. 4A shows a computer-implemented configuration change technique as used in systems that implement zero-code administration of containerized data management workloads, according to an embodiment.

FIG. 4B shows an automated dictionary-based translation facility as used in systems that implement zero-code administration of containerized data management workloads, according to an embodiment.

FIG. 4C shows a dictionary-enabled representation-agnostic term generation facility as used in systems that implement zero-code administration of containerized data management workloads, according to an embodiment.

FIG. 5A shows a first data management application configuration user interface as used in systems that implement zero-code administration of containerized data management workloads, according to an embodiment.

FIG. 5B shows a second data management application configuration user interface as used in systems that implement zero-code administration of containerized data management workloads, according to an embodiment.

FIG. 6 shows a data management application bring-up module that implements aspects of zero-code administration of containerized data management workloads, according to an embodiment.

FIG. 7A shows a first example set of system components as used in systems that implement zero-code administration of containerized data management workloads, according to an embodiment.

FIG. 7B shows a second example set of system components as used in systems that implement zero-code administration of containerized data management workloads, according to an embodiment.

FIG. 7C depicts a block diagram of a system to perform certain functions of a computer system, according to an embodiment.

FIG. 8A, FIG. 8B, FIG. 8C, and FIG. 8D depict virtualization system architectures comprising collections of interconnected components suitable for implementing embodiments of the present disclosure and/or for use in the herein-described environments.

### DETAILED DESCRIPTION

Aspects of the present disclosure solve problems associated with using computer systems for maintaining containerized applications on an ongoing basis while staying within the bounds of policy limitations, and while in observance of applicable governance rules and regulations. Addressing such foregoing problems has become impractically burdensome for administrators of containerized data management applications. These foregoing problems are unique to, and may have been created by, various computer-implemented methods for creating, and then maintaining containerized applications on an ongoing basis. Some embodiments are directed to approaches for automatically generating executable modules that observe and govern the use of infrastructure resources when running self-service Kubernetes workloads. The accompanying figures and discussions herein present example environments, systems, methods, and computer program products.

### Overview

One of skill in the art will recognize that ongoing administration of applications running in a containerized system involves at least two separate but inextricably intertwined computer management functions: (1) ongoing management of infrastructure (e.g., mostly pertaining to hardware resources), and (2) ongoing management of applications that run on said infrastructure. Typically, ongoing management of infrastructure is handled by a first type of human resource (often referred-to herein as an “IT person”), whereas ongoing management of applications is handled by a second type of human resource (often referred-to herein as a “DevOps person”).

Over time, it can happen that either or both the infrastructure needs and/or the application needs change. More particularly, it can happen that infrastructure changes and/or policy changes that apply to the infrastructure affect applications running on said infrastructure and/or it can happen that changes to the application themselves and/or policies that relate to the application affect the needs for certain infrastructure configurations. Accordingly, some mechanism needs to be provided such that changes to infrastructure, such as changes that are brought about by an IT person, are or can be recognized by a DevOps person. In the reverse, some mechanism needs to be provided such that changes to application demands (e.g., as specified by a DevOps person) is supported by changes to infrastructure (if needed) and implemented (if needed) by an IT person. In modern deployments the foregoing two mechanisms can be implemented by multiple processing paths that run concurrently and which interoperate by and between the multiple processing paths by use of well known computer processing mechanisms such as interrupts, semaphores, FORK/JOIN blocks, etc.

To further explain, consider that a DevOps person might want to ensure that data management operations pertaining to an application is sufficiently robust so as to survive an outage. In such a case, the DevOps person might define (or refer to) some sort of policy such as a policy that requires a replication factor equal to two. Now, recognize that this policy would impact the infrastructure at least to the extent that twice as much non-volatile storage needs to be provided. As such, when a policy is defined (or referred to) and enabled, observance/enforcement of the policy might affect both the application as well as the underlying infrastructure. Of course, it can happen that policies change over time, therefore some mechanism needs to be provided such that both the applications, or more specifically the data management aspects of the applications, can be responsive to changes in policy, while at the same time corresponding changes (e.g., demanded changes) in infrastructure can be handled.

Example embodiments are shown and described as pertains to the appended figures.

### Definitions and Use of Figures

Some of the terms used in this description are defined below for easy reference. The presented terms and their respective definitions are not rigidly restricted to these definitions-a term may be further defined by the term's use within this disclosure. The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances. As used herein, at least one of A or B means at least one of A, or at least one of B, or at least one of both A and B. In other words, this phrase is disjunctive. The articles “a” and “an” as used in this application and the appended claims should generally be construed to mean “one or more” unless specified otherwise or is clear from the context to be directed to a singular form.

Various embodiments are described herein with reference to the figures. It should be noted that the figures are not necessarily drawn to scale, and that elements of similar structures or functions are sometimes represented by like reference characters throughout the figures. It should also be noted that the figures are only intended to facilitate the description of the disclosed embodiments-they are not representative of an exhaustive treatment of all possible embodiments, and they are not intended to impute any limitation as to the scope of the claims. In addition, an illustrated embodiment need not portray all aspects or advantages of usage in any particular environment.

An aspect or an advantage described in conjunction with a particular embodiment is not necessarily limited to that embodiment and can be practiced in any other embodiment even if not so illustrated. References throughout this specification to “some embodiments” or “other embodiments” refer to a particular feature, structure, material, or characteristic described in connection with the embodiments as being included in at least one embodiment. Thus, the appearance of the phrases “in some embodiments” or “in other embodiments” in various places throughout this specification are not necessarily referring to the same embodiment or embodiments. The disclosed embodiments are not intended to be limiting of the claims.

### Descriptions of Example Embodiments

Many of the discussed embodiments have far-reaching implications. In some cases, these far-reaching implications intersect with broad areas of innovation that is or can be undertaken in pursuit of myriad optimization aspects of the techniques disclosed herein.

In addition to being responsible for rehosting/replication of a data management application itself and its configuration data, the disclosed techniques can rehost and replicate other application resources to a target. While staying within the spirit of the advances detailed herein, the target can be either a “warm” Kubernetes cluster (e.g., as in a so called “far disaster recovery” application) or the target can be a “hot” standby Kubernetes cluster (e.g., as in a so called “near disaster recovery” application). Additionally, or alternatively, the target can host a system such as Amazon's “S3” web storage and/or any other one or more long-term storage solutions. Such hosting can further include support for the various data protection and disaster recovery technologies that cover the range of a customer's recovery point objective (RPO) needs and/or a customer's recovery time objective (RTO) needs. Further, the herein-disclosed techniques provide support for application-specific and/or use case-specific data sharing techniques such as data sharing used in volume migration across Kubernetes and Openshift clusters (or vice-versa), and/or such as data sharing as used in use cases involving deduplication and/or copy management.

In addition to being responsible for rehosting/replication of a data management application itself and its configuration data, the disclosed techniques can provide support for repatriation of data and application resources from Kubernetes environments, including environments that are not running any particular operating system and/or not running any particular hypervisor.

Moreover, in addition to being able to deal with rehosting/replication of a data management application itself (and its configuration data) the disclosed techniques can provide support for out-of-band snapshotting as well as a corresponding restore. Specifically, in some embodiments, a customer will be able to create snapshots on an “as needed” basis (sometimes called “out-of-band” snapshotting). Similarly, using the herein-described techniques, a customer will be able to define and schedule out-of-band restore operations. As a matter of convenience, the foregoing out-of-band operations can optionally be handled while respecting a namespace that is local to a particular Kubernetes cluster.

Moreover, customers will have an option to define the metes and bounds of a particular data management application using labels and group/version/kind (GVK) designations. Further, some embodiments provide a summary (e.g., in a status field) of what has been snapshotted/captured as part of the specified application snapshot metes and bounds. The foregoing feature also provides for a safe, full application “restore”, where safe means that there are no instances/sub-entities that share conflicting identifiers in the target namespace. Even in cases where instances/sub-entities do share conflicting identifiers in the target namespace, it is sometimes possible to accomplish restoring even across namespaces. By default, however, snapshots at a target location will be created using the same namespace as was in use at the source.

Of particular note, Kubernetes clusters that are created using the herein-disclosed techniques are not limited to a single computing entity/unit. In fact, the herein-disclosed techniques support deployment of a single Kubernetes cluster that spans multiple computing entity/units.

Some embodiments support application-centric, out-of-band replication in two (or more) different availability zone (AZ) modes. Strictly as examples, support for application-centric, out-of-band replication can be done while situating the out-of-band replication activities (e.g., replication processing and storage of replicated data) either within a single AZ or across multiple AZs (e.g., spanning or otherwise involving multiple AZs for a single out-of-band replication facility.

### Intra-Cluster and Inter-Cluster Replication

In some situations, a customer will be able to require replication from one Kubernetes cluster to another Kubernetes cluster either (1) where the replication is within the same AZ, or (2) where the replication spans two or more different AZs. Replication across multiple intra-node Kubernetes clusters (e.g., where the multiple intra-node Kubernetes clusters are hosted on the same computing unit) is also supported. In the foregoing case 2, where the replication spans two or more different AZs, pairing between AZs can be performed automatically or in some pre-established pairing between AZs.

### Intra-Cluster and Inter-Cluster Namespace Handling

Replication across different namespaces within the Kubernetes cluster are handled automatically. Moreover, replication across multiple storage classes within the same Kubernetes cluster is supported.

### Policy Driven Snapshot Generation and Retention

An administrator can define one or more policies that serve to inform snapshot periodicity. Moreover, administrators can define a policy that includes a value or evaluable function the indicates how many snapshots should be retained at any given moment in time.

Of particular note, Kubernetes clusters that are created using the herein-disclosed techniques are not limited to a single computing entity/unit. In fact, the herein-disclosed techniques support deployment of a single Kubernetes cluster that spans multiple computing entity/units.

Some embodiments support policy driven snapshot generation and retention in two (or more) different availability zone modes. Strictly as examples, support for policy driven snapshot generation and retention can be done while situating the snapshot generation and retention facilities either (1) within a single AZ, or (2) across multiple AZs (e.g., spanning or otherwise involving multiple AZs to implement a single snapshot generation and retention facility).

### Infrastructure Views

Some embodiments provide control and monitoring facilities to administrators. More specifically, in various embodiments, administrators are provided the ability to view and govern a given Kubernetes cluster's usage of infrastructure resources (e.g., compute resources, storage resources, and network resources), as they are allocated and/or consumed by a Kubernetes cluster running on some particular underlying infrastructure. As is understood by those of skill in the art, the Kubernetes clusters as mentioned herein can derive from any Kubernetes distribution that might be ported to or otherwise made available for use on the underlying infrastructure.

### Supported Platforms

Kubernetes clusters can be created either on on-premises “on-prem” infrastructure and/or on clouds (e.g., public clouds or private clouds). Moreover, the techniques disclosed herein provide support for both stateless and stateful applications, including combinations of stateless and stateful applications. Strictly as examples, applications include database applications, service mesh applications, load balancing applications, and various observation applications (e.g., applications that capture time series data and calculate and retain metrics over such sets of time series data).

### Sample Use Cases

Strictly as examples, use cases might include (1) creating an entity to represent a Kubernetes cluster in some target infrastructure; (2) viewing the resources consumed by a Kubernetes (or alternative) cluster in a unified way (e.g., using a cluster overseer module), (3) upon administrative election, configuring one or more computing clusters within the semantics of (a) a locally hosted containerized application regime (e.g., Kubernetes) or (b) an industry standard cluster facility that supports containerized applications (e.g., OpenShift); (4) governing the operation of the Kubernetes cluster in accordance with possibly changing governance and policy specifications; (5) establishing and enforcing compute quotas using a profile-based facility that handles quotas for virtual machines as well as other virtualized entities; and (6) establishing workflows to define and register a cluster (sometimes referred to as “onboarding” a cluster).

As is now understood, changing policy parameters may happen on an ongoing basis and at any moment in time. As such, some embodiments include a policy execution observation module that serves to capture such changes and provide such changes (or derivatives therefrom) to downstream processing

Various graphical user interfaces are specially configured to support any/all of the foregoing use cases. Strictly as one illustrative example, a graphical user interface might have a “left panel” for entry and display of names for any one or more Kubernetes clusters. The same (or different) graphical user interface might also have a “right panel” landing page that offers administrative access to any applicable APIs. By default, or on administrative command, the graphical user interface displays summary/aggregate views of generated (or merely specified) Kubernetes clusters. In this manner, an administrator is able to explicitly group resources that correspond to any particular Kubernetes cluster or group of Kubernetes clusters.

As can now be seen, the foregoing provides a complete ecosystem in which an administrator can observe and run self-service Kubernetes workloads, specify how self-service Kubernetes workloads should be governed, as well as specify how self-service Kubernetes workloads should be permitted or denied (e.g., by policies) use of infrastructure resources when running self-service Kubernetes workloads. The following figures and corresponding written description further explain how to build and use systems that implement zero-code administration of containerized data management workloads.

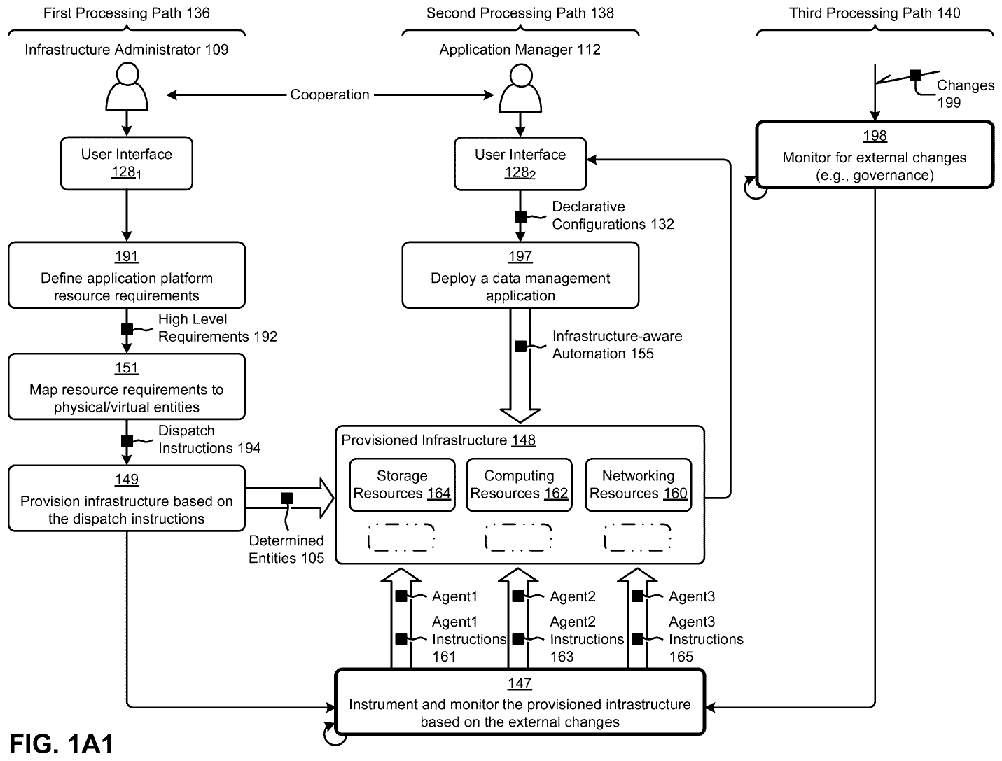

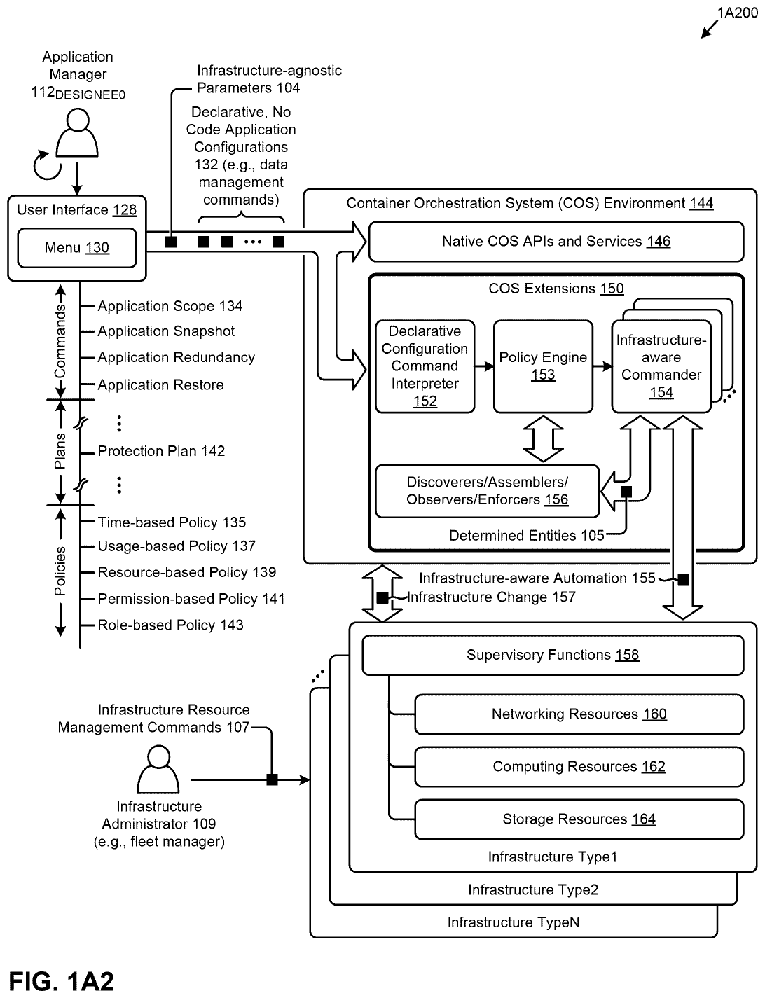

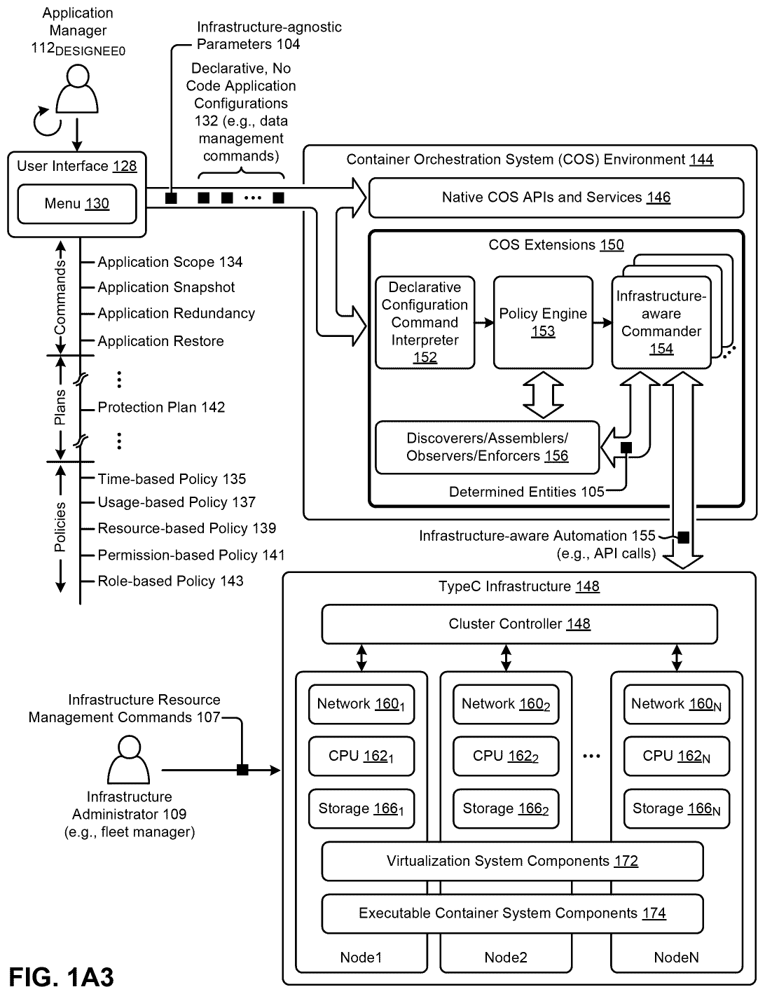

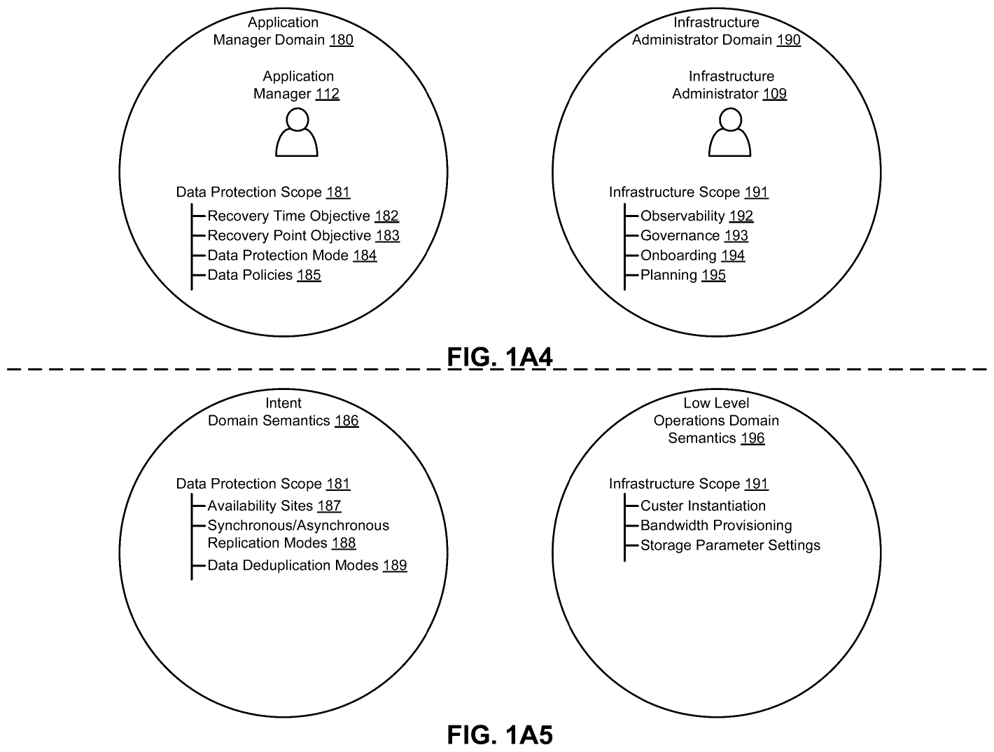

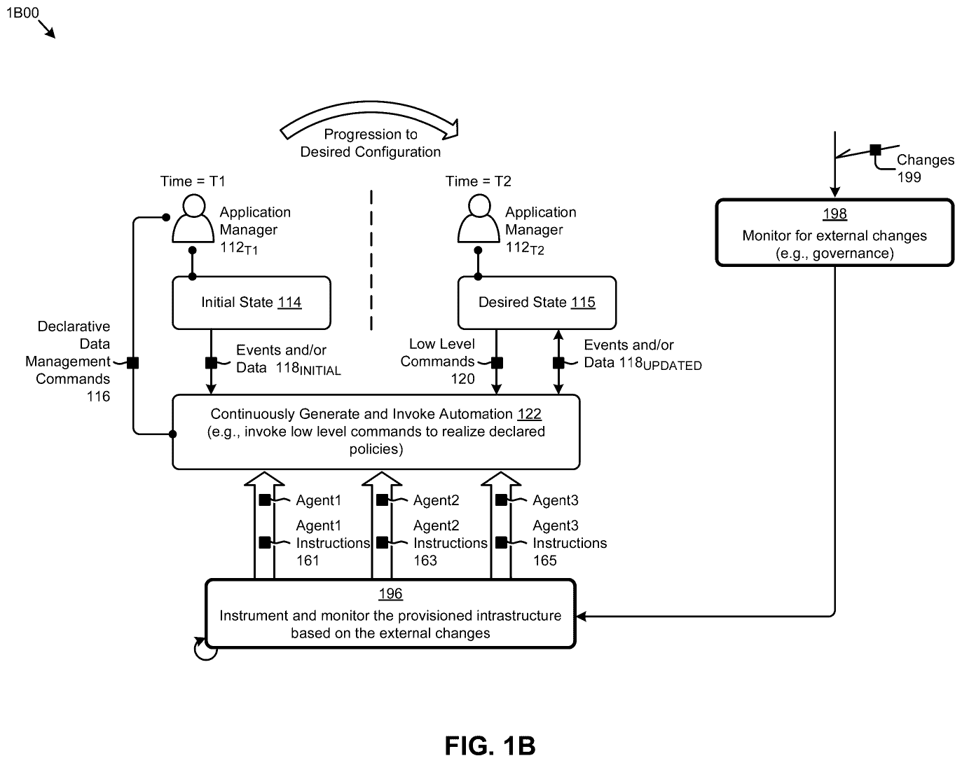

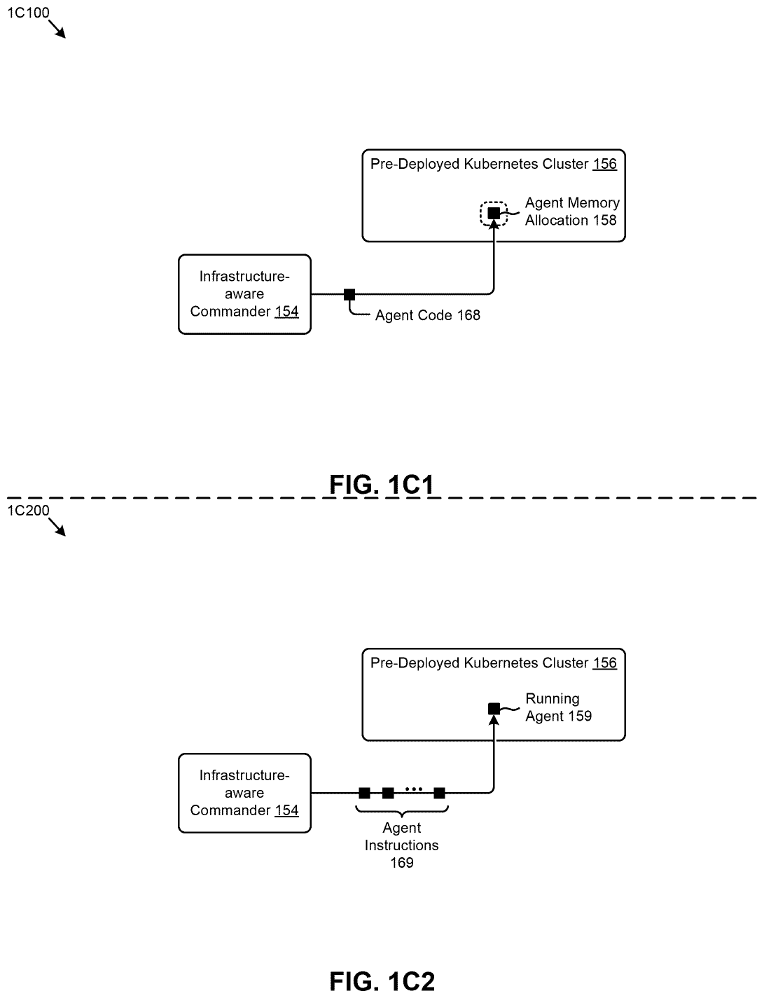

FIG. 1A1 exemplifies a system for ongoing administration of a data management workload using zero-code administration techniques.

The figure is being presented to illustrate how multiple independent processing paths can be coordinated between each path so as to continuously monitor provisioned infrastructure based on changing conditions. More specifically the figure is being presented to illustrate how multiple independent processing paths can be coordinated to be responsive to external changes—such as policies—so as to maintain operability of an underlying data management application that runs on the provisioned infrastructure.

As shown, there are three processing paths: (1) a first processing path 136 pertains to infrastructure provisioning, which is initiated by an infrastructure administrator 109 via his/her interaction with a user interface 1281, (2) a second processing path 138 pertains to deployment of a data management application, which is initiated by an application manager 112 via his/her interaction with a user interface 1282, and (3) a third processing path 140 pertains to ongoing monitoring (e.g., via module 198) and handling (e.g., via module 147) of changes 199, which changes affect the operation or capabilities of the data management application and/or which changes affect the operation or capabilities of the provisioned infrastructure.

The infrastructure administrator 109 and the application manager 112 work cooperatively such that provisioned infrastructure 148 is established so as to provide sufficient capabilities for at least an initial deployment of the aforementioned data management application to execute. More particularly, the infrastructure administrator defines (e.g., via module 191) infrastructure resource requirements such that the defined infrastructure can host the data management application as specified by the application manager.

Further details regarding general approaches to forming initial deployments of the aforementioned data management application are described in U.S. patent application Ser. No. 18/819,997 titled “ZERO-CODE ADMINISTRATION OF DATA MANAGEMENT FOR CONTAINERIZED WORKLOADS”, filed on Aug. 29, 2024, which is hereby incorporated by reference in its entirety.

As depicted, the infrastructure provisioning can proceed substantially in parallel with the data management application deployment, so long as components of the provisioned infrastructure 148 are established in time to host corresponding functions of the data management application. For example, the storage resources 164 of the provisioned infrastructure can be allocated in a just-in-time manner to be able to satisfy storage needs of the data management application. Similarly, the computing resources 162 and the networking resources 160 of the provisioned infrastructure can be brought to bear in a just-in-time manner to be able to satisfy the computing and networking needs of the data management application.

The second path traverses and makes use of a data management application deployment facility (e.g., module 197) that deploys the aforementioned data management application in accordance with and/or in response to a set of declarative configurations 132. The data management application deployment facility responds to the set of declarative configurations by providing infrastructure-aware automation 155, which in turn results in an initial deployment of the data management application onto the provisioned infrastructure. As an example, and expressly not to limit the generality of the meaning of the term data management application, a data management application might be a snapshotting facility, or might be a component of a disaster recovery facility, etc.

Referring again to the first path, it can happen in some cases that an infrastructure administrator takes a role in mapping resource requirements (e.g., resource requirements of the initial deployment of the data management application) to physical or virtual entities (e.g., physical storage or virtual storage), whereas in other cases, such a mapping is performed autonomously by a computing module (e.g., module 151). In exemplary cases, the mapping is accompanied by emission of dispatch instructions 194 that are in turn interpreted by a provisioning facility (e.g., module 149). Such interpretation may raise provisioning of any number of determined entities 105, any one or more of which can be situated into the provisioned infrastructure 148. In some embodiments, system-specific categories and/or system-specific labels can be used to derive determined entities 105 and/or to raise provisioning of said determined entities. In some cases, the determined entities can be situated into the provisioned infrastructure using declarative no-code techniques and/or intent-driven techniques.

Further details regarding general approaches to intent-driven techniques are described in U.S. Patent Publication No. 11,900,172, filed Jul. 29, 2022, and titled, “COMPUTING CLUSTER BRING-UP ON PUBLIC CLOUD INFRASTRUCTURE USING EXPRESSED INTENTS” which is hereby incorporated by reference in its entirety.

Now, returning to the discussion of the three processing paths, the third processing path for ongoing monitoring and handling of environmental changes that would at least potentially affect the operation or capabilities of the data management application and/or which changes affect the operation or capabilities of the provisioned infrastructure. It should be noted that, in this embodiment, the third processing path is completely automated. That is, a change monitoring facility (e.g., module 198) can not only detect occurrences of environmental changes that would at least potentially affect the operation or capabilities of the data management application, but can also synthesize code that serves to instrument and monitor the provisioned infrastructure (module 147) by instancing agents (e.g., agent1, agent2, agent3) and/or instructions (e.g., agent1 instructions 161, agent2 instructions 163, agent3 instructions 165). Instantiation and invocation of such agents and/or agent instructions are able to continuously monitor the infrastructure and/or the deployed data management application so as to realize and/or enforce policies that related to the environmental changes. Strictly as one example, it might be that an administrator wants to be sure that snapshots are retained for a period of time (e.g., 5 years) so as to satisfy some customer request or some governmental authority's requirement. A corresponding policy can be established to both realize the request or requirement as well as to enforce aspects of the realized policy that correspond to the request or requirement.

There are many ways for an application manager, possibly with cooperation by an infrastructure administrator, to be able to maintain compliance with any sort of requirement (e.g., governance requirements, export controls, etc.) in the face of external changes, such as changes in policies pertaining to a data management application or such as changes in governmental boundaries or changes in reach of legislated controls, and/or other types of external changes. This embodiment involves managing policies and other external factors within the context of a container orchestration system.

One aspect of managing policies and external factors within a container orchestration system is that ongoing policy management can be handled by an application manager (sometimes referred to as a “DevOps person”) who might not be well versed in, or even familiar with, the underlying computing infrastructure. As such, the application manager can interact with the system of FIG. 1A1 in an infrastructure-agnostic way. Furthermore, to do so involves automation that translates infrastructure-agnostic concepts (e.g., declarative no-code application configuration) into infrastructure-aware automation.

Such infrastructure might be or include aspects of a hyperconverged computing infrastructure (HCl) deployment. In example embodiments, a containerized system such as Kubernetes can be deployed on top of storage infrastructure that functions within an HCl deployment. In some situations (e.g., within a data center), the skills of infrastructure administrator 105 might include both skills pertaining to configuration and ongoing operation of computing clusters within the HCl deployment, as well as skills pertaining to configuration and ongoing operation of the containerized system. In other situations (e.g., in a typical on-premises situation), the needed skills pertaining to both the configuration and ongoing operation of computing clusters within the HCl deployment as well as skills pertaining to configuration and ongoing operation of a containerized system might be variously divided between two or more infrastructure administrators, each having particular infrastructure-related domain expertise.

As can be understood by those of skill in the art, an infrastructure manager who is skilled regarding configuration and ongoing operation of a containerized orchestration system can merely honor or otherwise configure components of the containerized orchestration system in a manner that stays within the operational boundaries of an underlying HCl cluster. In some cases, a first type of infrastructure manager instructs the containerized orchestration system in a manner that stays within the operational boundaries of an underlying HCl cluster. In other cases, a second type of infrastructure manager instructs components of the underlying HCl cluster to be configured in a manner that supports the needs of the overlying containerized orchestration system. More particularly, an overlying containerized orchestration system might host and/or otherwise enable initiation and ongoing execution of any number of applications, including data management applications, many of which are discussed in detail hereunder.

One way to enable ongoing management of data management applications involves implementation of extensions to a container orchestration system. Example container orchestration system extensions that are specifically configured to translate or otherwise morph infrastructure-agnostic commands into infrastructure-aware automation are shown and described as pertains to the partitioning FIG. 1A2.

FIG. 1A2 shows an example partitioning of a system that implements zero-code ongoing administration of containerized data management workloads. As shown, system 1A200 includes an implementation of a container orchestration system (COS) that is situated in a corresponding container orchestration system environment 144 (e.g., a Kubernetes environment).

To illustrate how this works, the figure shows a depiction of a DevOps person (e.g., application manager 112_{DESIGNEE0}) interacting with user interface 128 of the container orchestration system. One result of this interaction is generation of one or more declarative, no-code application configurations 132 that are formatted so as to be consumed by both native COS APIs and services 146 as well as by COS extensions 150. In some embodiments, a particularly-define data management language is defined so as to increase the level of abstraction of concepts that are then considered within the province of the DevOps person. As such, providing a data management language also reduces the need for a DevOps person to understand aspects of the infrastructure, preferring to leave dealing with such details to an IT person such as depicted by the shown infrastructure administrator 109. The shown declarative no-code application configurations 132 might be codified using nouns and verbs of the foregoing particularly-define data management language.

As shown, a declarative configuration command interpreter 152 is one of many components within an environment that supports COS extensions. A policy engine 153 interprets policies so as to facilitate automated generation of commands (e.g., a first portion of infrastructure-aware automation 155) and/or intents (e.g., a second portion of infrastructure-aware automation 155) and/or agent code (e.g., a third portion of infrastructure-aware automation 155), any of which, either singly or in combination, can be deployed (e.g., by infrastructure-aware commander 154) to achieve the one or more declarative, no-code application configurations that are hoped for by the DevOps person.

Further details regarding general approaches to processing intents are described in U.S. Patent Publication No. 11,900,172 titled “COMPUTING CLUSTER BRING-UP ON PUBLIC CLOUD INFRASTRUCTURE USING EXPRESSED INTENTS” issued on Feb. 13, 2024, which is hereby incorporated by reference in its entirety.

As heretofore mentioned, an application manager or DevOps person might not be familiar with the underlying computing infrastructure. This situation has become more and more prevalent in recent times since, with the advent of higher-level computer capabilities such as self-service portals, it becomes cost effective for an enterprise to employ application managers who, while they might be intimately familiar with the application and how the application achieves business objectives, they might not be, and in fact need not be, conversant with low level computer management facilities.

As can be seen from the partitioning of FIG. 1A2, the application manager is isolated from the underlying computing infrastructure.

As used herein the term “computing infrastructure” refers to any sort of computing and/or networking, and/or storage equipment.

Although there might be an application manager that interacts with the computing system at higher level of declarative, no code semantics, there might also be an infrastructure administrator 109 (sometimes called a “fleet manager”) that is able to interact with the computing system at lower levels. For example, an infrastructure administrator or fleet manager is able to issue infrastructure resource management commands 107 onto a given infrastructure. In the example shown, and specifically referring to infrastructure type1, the infrastructure resource management commands might involve networking resources 160, computing resources 162, storage resources 164, and potentially supervisory functions 158. Moreover, because the infrastructure-aware commander 154 and/or other components of the COS extensions 150 is able to automatically synthesize infrastructure-aware automation, it often happens that the infrastructure administrator need not be involved at all to issue infrastructure resource commands. In some situations, the infrastructure administrator is an IT person, whereas the application manager is not an IT person (e.g., perhaps a ‘normal’ user or perhaps a DevOps person).

Now, it is illustrative to explain not only how an application manager might interact with the system, but also to offer some illustrative examples of the types of interaction that is within the province of an application manager. As shown, the application manager interacts with user interface 128, which may in turn offer a variety of widgets such as menu 130. Strictly as an illustrative example, such a menu might offer the application manager a mechanism to issue commands, define plans, and devise or revise policies. This is depicted in FIG. 1A2 by the occurrence of commands that apply to a particular data management application functionality. That is, and as shown, commands destined for a particular data management application might involve defining application scope 134, defining application snapshot variables, defining application redundancy parameters, defining application restore parameters, etc. Similarly, and as shown, policies that pertain to a particular data management application might include aspects of a time-based policy 135 and or aspects of a usage-based policy 137 and/or aspects of a resource-based policy 139 and/or aspects of a permission-based policy 141 and/or aspects of a role-based policy 143. Any of the foregoing commands as well as any of the foregoing policies might be used in the specification of one or more data management application plans (e.g., protection plan 142).

In this embodiment the mechanism for converting or morphing from infrastructure-agnostic parameters and/or declarative intents and/or no code application configurations might involve a suite of container orchestration system extensions. Referring to the partitioning of the shown COS extensions 150, one can observe that various modules that make up the aforementioned container orchestration system extensions are configured to cooperate with others of said various modules. In this specific implementation a declarative configuration command interpreter 152 interacts with policy engine 153 (e.g., using data management language constructs), which in turn interacts with and infrastructure-aware commander 154, of which there may be multiple instances, as shown. Further, the infrastructure-aware commander as well as the policy engine, for any COS extension might avail of the shown module 156, which module is specifically configured to discover characteristics of underlying infrastructure, and which is specifically configured to assemble or synthesize infrastructure-aware automation that in turn is deployed so as to carry out the functions of observation and enforcement.

In exemplary cases, the policy engine includes a scheduler function in addition to the assembly and synthesis functions such that any particular individual or combination of assembled and/or synthesized computing agents and their corresponding schedules (e.g., for invoking and re-invoking said agents and entities that are acted upon by the agents) can be determined at the time that a policy is considered. In fact, certain embodiments are capable of automatically determining what entities (e.g., determined entities 105) are pertinent to the scheduling and application (e.g., enforcement) of any particular policy or policies.

Having the combination of determined entities and corresponding agents sets up the scenario where various COS extensions 150 are singly or in combination, capable of providing infrastructure-aware commands to the underlying infrastructure of any type. This is a sought-after scenario because it facilitates ongoing management of data management applications at a high level (e.g., using infrastructure-agnostic parameters 104) even when there may be changes to the underlying infrastructure. In various systems, such changes can happen as a consequence of IT-initiated changes to the infrastructure, and/or such changes can happen as a consequence of migrating from first type or configuration of infrastructure (e.g., the shown infrastructure type1) to a second type or configuration of infrastructure (e.g., the shown infrastructure type2, . . . , infrastructure typeN).

Continuing this discussion where a combination of determined entities and corresponding agents are used for the purpose of providing infrastructure-aware commands to the underlying infrastructure of any type, it should be noted that the determination of said entities, as well as corresponding instantiations and/or modifications, can happen at any moment in time, and often do occur on an ongoing basis long after initial determination of said entity. For example, suppose that infrastructure-aware commands are provided to the underlying infrastructure such that an initial disaster recovery capability is initially configured. Now, further consider that a change to some parameter of the disaster recovery capability might infer a corresponding change to the infrastructure. Such a change to the infrastructure can be carried out in response to the changed disaster recovery parameter. Furthermore, such an infrastructure change 157, including candidate (but not yet implemented) changes can be detected, analyzed for corresponding needed further infrastructure changes, and realized all without further action by the DevOps person. Furthermore, such a change to the infrastructure can be detected, analyzed for corresponding further changes, and implemented all without further action by the IT person. Additionally or alternatively, a change to the infrastructure can be carried out in response to ongoing enforcement and/or execution of a policy, even in situations where there is no change to the infrastructure.

The foregoing presentation of FIG. 1A2 pertains to merely some possible embodiments and/or ways to implement a container orchestration system. Many variations are possible, for example, the container orchestration system as comprehended in the foregoing can be implemented in any environment, one example of which is shown and described as pertains to FIG. 1A3.

FIG. 1A3 exemplifies an alternative container orchestration system that implements zero-code administration of containerized data management workloads. As an option, one or more variations of container orchestration system or any aspect thereof may be implemented in the context of the architecture and functionality of the embodiments described herein and/or in any environment.

The figure is being presented to illustrate how the underlying infrastructure can be of any type. The foregoing FIG. 1A2 depicted a generalized infrastructure, type 1, type 2, . . . , type N, however it often happens that such an underlying infrastructure is a computing cluster that is implemented using virtualization system components. This is shown in FIG. 1A3 by the appearance of cluster controller 148, virtualization system components 172, and executable container system components 174. Such architectural items span across any number of nodes (e.g., node1, node2, . . . , nodeN). Furthermore, each node can have its own network resources (e.g., network 160₁, network 160₂, . . . , network 160_{N}), its own computing resources (e.g., CPU 162₁, CPU 162₂, . . . , CPU 162_{N}), as well as its own storage resources (e.g., storage 1661, storage 1662, . . . storage 166N).

It now becomes apparent that the container orchestration system—including any container orchestration system extensions—can be implemented independent of, and can operate independent of, whatever underlying infrastructure (e.g., typeC infrastructure 148) is present.

The foregoing presentation of FIG. 1A3 pertains to merely some possible embodiments and/or ways to implement instructions. Many variations are possible, for example, the container orchestration system as comprehended in the foregoing can be implemented in any environment, one example of which is shown and described as pertains to FIG. 1A4.

FIG. 1A4 exemplifies the differences between the operational domain of an application manager as compared to the operational domain of an infrastructure administrator. As shown, application manager 112 interacts within application manager domain 180 in order to define data protection scope 181, which may include data protection parameters such as a parameter for a recovery time objective 182, a perimeter for a recovery point objective 183, one or more parameters that define a data protection mode 184 or modes, as well as various data policies 185.

These application manager domain concepts are at a higher level of abstraction than are the concepts that pertain to the infrastructure administrator domain. This is shown by the constituents of the infrastructure administrator domain 190. Specifically, and as shown, an infrastructure administrator 109 interacts within the bounds of a particular infrastructure scope 191, which may be determined by the nature of underlying infrastructure. In the context of data management applications, the infrastructure administrator interacts within that domain to specify infrastructure-specific observability 192, infrastructure-specific governance 193, infrastructure-specific onboarding 194, and infrastructure-specific planning 195.

As is now understood from the foregoing, an application manager would tend to operate using the semantics of intents, whereas an infrastructure administrator would tend to operate using the semantics of low level operations.

FIG. 1A5 exemplifies the differences between intent domain semantics as compared to a low level operations domain. As shown, intent domain semantics 186 are constituted within a data protection scope 181. Purely as an example, data protection scope 181 might include semantics that pertain to availability sites 187, synchronous or asynchronous replication modes 188, and/or semantics pertaining to data deduplication modes 189. This level of intent domain semantics is substantially infrastructure agnostic. This is by design because the DevOps person, although such a dedicated person would be very familiar with the functioning of a data management application, might not know, or more particularly need not know, any details about infrastructure. More specifically, the DevOps person is often supported by an infrastructure administrator who deals with low level operation domain semantics 196, which in turn would correspond to a particular given infrastructure scope 191. The infrastructure scope in turn may be defined, wholly or partially, by a particular cluster configuration or cluster instantiation, and/or wholly or partially by a given bandwidth provisioning and/or wholly or partially by a set of storage parameter settings.

FIG. 1B pertains to merely some possible embodiments and/or ways to implement a declarative, no-code, application-level configuration management regime. Many variations are possible. For example, the declarative, no-code, application-level configuration management regime 1B00 as comprehended in the foregoing can be implemented in any environment. More particularly, the figure illustrates how a subject system can progress from an initial configuration (e.g., initial state 114) to a particular desired configuration. As shown, specifically referring to time=T1, application manager 112_{T1} interacts with an initial configuration of the subject computing system using one or more declarative data management commands 116. During such initial interactions there may occur any number of observable events and/or transmissions of data 118_{INITIAL}. Such can be used to invoke low level commands to realize declared policies. That is, execution of low level commands and/or realization of declared policies can be triggered in response to any number or combination of observable events and/or transmissions of data.

Such declarative data management commands are interpreted by a module that is configured to continuously generate and invoke automation 122 (e.g., computing agents) that are defined to carry out said low level commands in order to achieve the intent of the declarative management commands and/or to realize declared policies. Over time, in particular as the foregoing generated and invoked automation is executed, the subject computing system converges towards desired state 115. During this time frame, any number of low level commands 120 may be executed over or by the subject computing system, and furthermore, during this time (or later, as the case may be) any number of updated events and/or data 118_{UPDATED} that can occur and/or be optionally reported to application manager 112_{T2} at time=T2.

It should be noted that at any moment in time there may be incoming changes (e.g., changes 199) that influence and/or define how to instrument and monitor the provisioned architecture based on the occurrence of such a change. In various embodiments, module 147 is configured to synthesize agents (e.g., agent1, agent2, agent3, etc.). Similarly, in various embodiments, module 147 is configured to synthesize agent instructions (e.g., agent1 instructions 161, agent2 instructions 163, and agent3 instructions 165) such that the computing system is subjected to continuously generated and invoked automation.

FIG. 1C1 shows an agent-enabled Kubernetes cluster configuration technique that is used in systems that implement zero-code administration of data management for containerized workloads. As an option, one or more variations of agent-enabled Kubernetes cluster configuration technique 1C100 or any aspect thereof may be implemented in the context of the architecture and functionality of the embodiments described herein and/or in any environment.

The figure depicts certain interactions between infrastructure-aware commander 154 and a pre-deployed instance of a Kubernetes cluster. As shown, infrastructure-aware commander 154 delivers agent code 168 to the pre-deployed Kubernetes cluster. A running instance of the subject target Kubernetes cluster in turn allocates sufficient resources in the Kubernetes cluster to accommodate bring-up and ongoing execution of the agent.

Any given agent can have an initial configuration (e.g., for bootstrapping the deployment) as well as an ongoing configuration. On an ongoing basis a running agent can receive instructions that cause the agent to take specific steps at a particular time. One possible embodiment of a system that causes the agent to take specific steps at a particular time in response to agent instructions is shown and described as pertains to FIG. 1C2.

FIG. 1C2 shows an agent-enabled Kubernetes cluster maintenance technique that is used in systems that implement zero-code administration of data management for containerized workloads. As an option, one or more variations of agent-enabled Kubernetes cluster maintenance technique 1C200 or any aspect thereof may be implemented in the context of the architecture and functionality of the embodiments described herein and/or in any environment.

As shown, pre-deployed Kubernetes cluster 156 hosts running agent 159, which running agent is situated in the pre-deployed Kubernetes cluster due to operation of the deployment described in FIG. 1C1. The running agent receives agent instructions 169. The agent then takes specific steps at particular time(s) in response to the received agent instructions. In this embodiment, agent instructions 169 are provided by infrastructure-aware commander 154 under a “push” protocol, however other modules may be used to provide agent instructions, either directly or indirectly, to the running agent. In fact, in some situations the running agent requests agent instructions under a “pull” protocol.

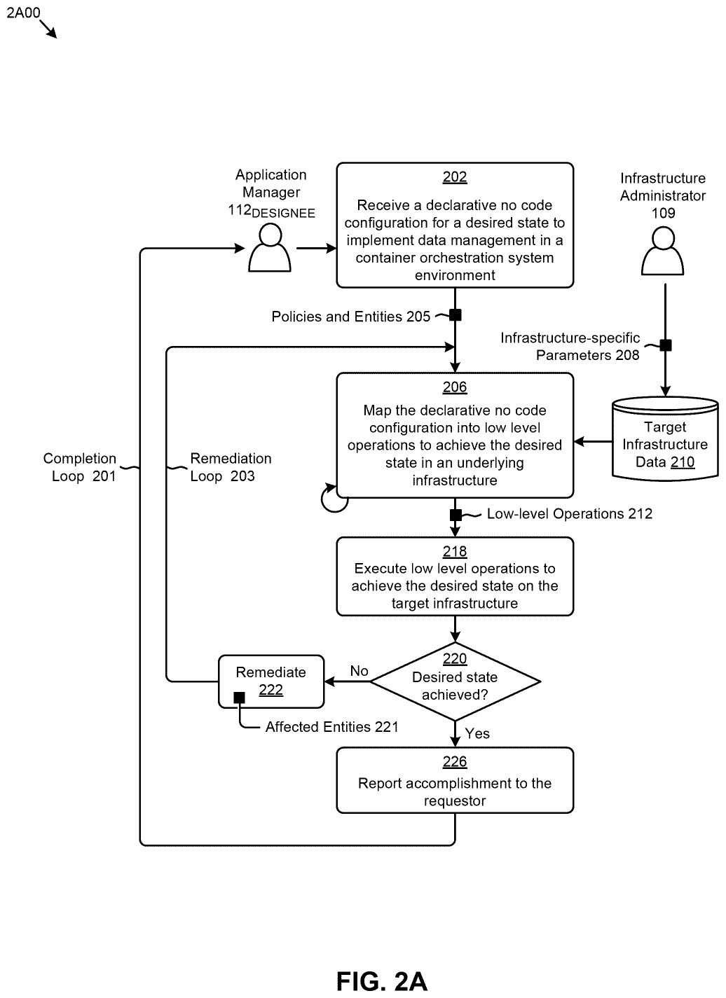

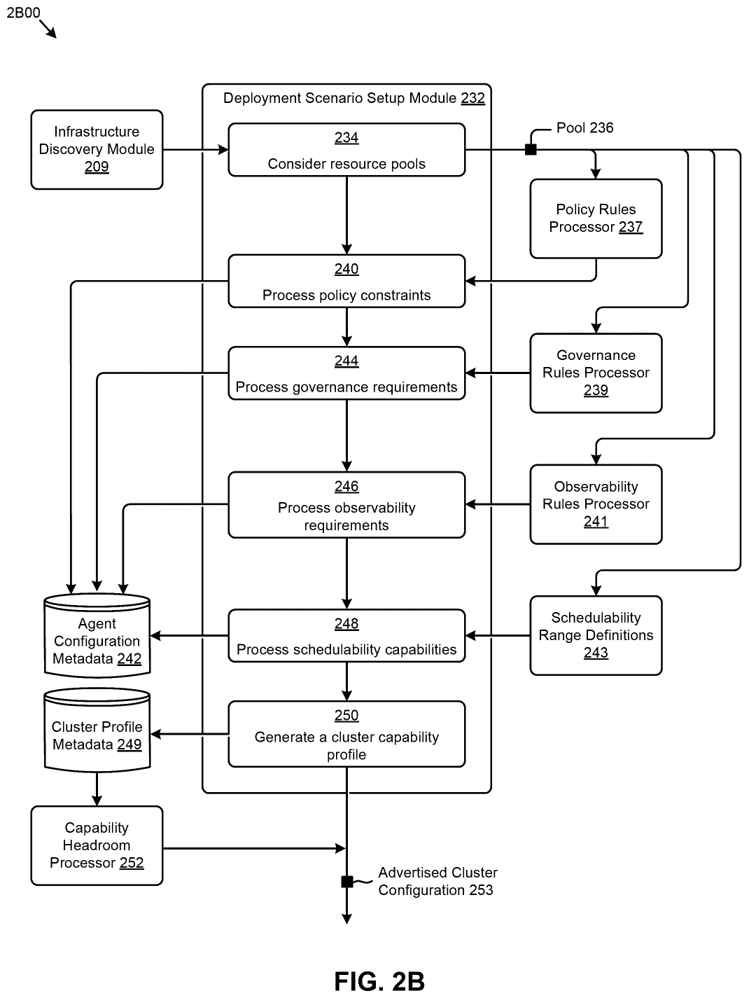

The foregoing discussions of FIG. 1C1 and FIG. 1C2 pertain to merely some possible embodiments and/or ways to implement agent-enabled techniques. Many variations are possible, for example, the foregoing agent-enabled techniques as comprehended in the foregoing can be implemented in any environment or in accordance with any scenario. In fact, any scenario can be defined with respect to any container orchestration system and/or any container orchestration system environment, of which Kubernetes is merely one example. One example of how to bring up a containerized data management workload that comports with specific resource requirements and constraints of a particular deployment scenario is discussed hereunder as pertains to FIG. 2A and FIG. 2B.

FIG. 2A shows a technique to implement zero-code administration of data management for containerized workloads. The figure depicts an operation flow 2A00 that results in accomplishment of bringing up a data management application. This particular flow is initiated by an application manager, such as application manager 112_{DESIGNEE1} (e.g., a DevOps person). In particular, the application manager provides inputs, possibly using a graphical user interface (GUI) to the flow (at step 202). The inputs may be in the form of a declarative no-code configuration for a desired state to be achieved in a container orchestration system. In some cases, and as shown, the declarative no-code configuration includes policies and entities 205, any of which may be provided as inputs and/or produced as (possibly modified) outputs. At step 206, the declarative no-code configuration is mapped into low level operations 212 (e.g., API calls) that, either singly or in combination with other low level operations, serve to foster achievement of the desired state on some particular computing infrastructure.

Specifically, the desired state is achieved within or across or coordinated via any number of executable containers of the identified container orchestration system. The processing of step 206 can be informed by the shown target infrastructure data 210, which may in turn be informed by any one or more infrastructure-specific parameters 208. It sometimes happens that a DevOps person and/or an associate can specify infrastructure-specific parameters. Additionally or alternatively, infrastructure-specific parameters can be automatically generated.

One possible result arising from the processing of step 206 is a set of infrastructure-specific intents and/or low level operations 212, which, singly or in combination serve to achieve the desired state on the target infrastructure. Such achievement may require multiple iterations through step 218. Accordingly, decision 220 serves to check if the desired state has been achieved. In some cases, it is merely a matter of time before the desired state is achieved. In other cases, some remediation is needed. As such, when the “No” branch of decision 220 is taken, step 222 serves to remediate the fact that the desired state has not yet been achieved. This is accommodated by providing a remediation loop 203. In some cases, the remediation step modifies parameters for or of affected entities 221.

When the desired state is achieved, the “Yes” branch of decision 220 is taken and the accomplishment is reported (step 226) to the DevOps person (e.g., via the shown completion loop 201). In subsequent processing (e.g., as per sequential processing) or in any downstream processing (e.g., as per parallel processing), there may be a further desired state, and a second further desired state after that, and so on.

The foregoing technique to implement zero-code administration of data management for containerized workloads can be practiced in any environment and/or in correspondence to any sort of data management scenario and/or in accordance with any deployment scenario, examples of which are shown and described as pertains to FIG. 2B.

FIG. 2B shows various deployment scenario setup considerations that are profiled for use in systems that implement zero-code administration of data management for containerized workloads. As an option, one or more variations of deployment scenario setup considerations 2B00 or any aspect thereof may be implemented in the context of the architecture and functionality of the embodiments described herein and/or in any environment.

As previously mentioned, and for the purpose of a DevOps person's setup and ongoing management of a data management application, it is desired to automatically define a Kubernetes cluster that comports with specific resource requirements and constraints of a particular deployment scenario. The particular embodiment of FIG. 2B depicts a freestanding instance of deployment scenario setup module 232, which module is configured to be able to comprehend the totality of physical and logical constraints that are applicable with respect to setup and ongoing management of a data management application.

As shown, this embodiment considers (1) previously vetted pools (e.g., pool 236) of computing infrastructure, (2) policy constraints (e.g., based on outputs of policy rules processor 237 or other codifications), (3) governance requirements (e.g., based on outputs of governance rules processor 239 or other codifications), (4) observability requirements (e.g., based on outputs of observability rules processor 241 or other codifications), and (5) schedule-ability capabilities (e.g., based on outputs of schedule-ability range definitions 243 or other codifications).

As used herein, a “policy” or a “policy rule” or a “policy constraint” refers to a computerized codification of a sought-after behavior of a data management application. A policy might describe a RPO such as a user-defined limit or threshold of acceptable data loss in the event of a failure. A policy refers to the desired behavior or state or situation rather than referring to any particular way to enforce or implement the policy. For example, if an RPO specifies “1 hour” (of loss of data), one way to implement such an RPO would be to take a snapshot every 1 hour. Thus, in the very worst-case event of a restore after a failure, at most “1 hour's worth” of data would be (acceptably) lost. As another example, a synchronous replication regime might be followed to achieve an aggressive RPO such that zero (or at least much less than 1 hour's worth of data) would be lost.

As used herein, the term “governance” or “governance rules” or “governance limits” refer to any set of controls and/or management practices that seek to ensure efficient, secure, and operationally-compliant operation of a computing cluster. Strictly as an example, a governance rule might specify a limit or threshold on how much bandwidth data a particular data management application can use. Additionally or alternatively, a governance rule might specify a limit or threshold on how much storage (e.g., gigabytes of storage) snapshots can consume. Governance policies are often specified by infrastructure administrators in a manner such that self-service users can merely acknowledge and/or agree to a governance policy without having to calculate any values or parameters that underly that governance policy.

As used herein, “observability” or “observability rules” refer to a computerized codification of a degree or granularity of interaction with users during the time that a data management application is running. For example, an observability rule might specify that a warning is emitted (e.g., to a user) in the event that actual usage of bandwidth is approaching a given governance limit. Additionally or alternatively, an observability rule might specify when (e.g., under what conditions) and how (e.g., as an alert, in a summary, etc.) to report a governance policy violation (e.g., an RPO violation), and/or to report a calculated health of a storage volume, etc.

As used herein, “schedule-ability” or “schedule-ability rules” refer to techniques for determining workload placement and triggering based on storage failure domains. For example, when determining a secondary location (e.g., a secondary failure domain) for storage of a collection of snapshots, the secondary location workload that receives the snapshots from a primary location (e.g., in a primary failure domain) would need to have enough storage capacity (and corresponding quota) to receive and retain as many snapshots from a primary location as would be needed to satisfy any in-force governance rules. Additionally or alternatively, when determining a secondary location (e.g., a secondary failure domain) for storage of a collection of snapshots, the workload to receive such snapshots would need to be provisioned with sufficient bandwidth as would be needed to receive the snapshots from a primary location (e.g., in a primary failure domain) at a rate at least as fast as the data of the snapshots are being produced. Additionally or alternatively, when determining a secondary location for placement of a data management workload, the secondary location must be provisioned with at least as much storage capacity and/or bandwidth availability as would be needed to satisfy any in-force governance rules.

Based on performance of the operations of the deployment scenario setup module 232 (e.g., operation 234, operation 240, operation 244, operation 246, operation 248, and operation 250), a vetted Kubernetes cluster configuration is emitted as an advertised cluster configuration 253, which in turn is used by downstream processing to establish a Kubernetes cluster that satisfies at least the requirements of the advertised cluster configuration.

To vet any potential Kubernetes cluster capability configuration for suitability against a particular data management application, all of, or at least some of, the known constraints and requirements are to be considered. More particularly, the logical aspects of the foregoing known constraints and requirements are to be considered with respect to the physical aspects of a computing resource pool. This can be accomplished by processing the flow that is shown within the shown deployment scenario setup module. More specifically, what is needed, and what is provided by operation of the deployment scenario setup module, is a desired cluster profile (e.g., as depicted by cluster profile metadata 249) and instructions or data sufficient to generate agent code (e.g., as depicted by agent configuration metadata 242).

One way to generate a desired cluster profile and any instructions or data sufficient to generate agent code is by processing the shown flow. The flow begins at operation 234 by interrogating infrastructure discovery module 209 so as to obtain one or more resource pools that had already been defined within the then-known constraints (e.g., size of the infrastructure, logical availability based on tenancy, etc.). Then, the one or more resource pools are subjected to a series of processing steps that are configured specifically to compare logical requirements and constraints against the physical characteristics of the foregoing resource pools.

As shown, each of the viability checks (e.g., operation 234, operation 240, operation 244, operation 246, operation 248, and operation 250) take in specific data from various sources and perform logical checks to vet a particular pool against some set of data management needs.

As used herein, a “pool” refers to a logical partition of the infrastructure on which a Kubernetes cluster is provisioned. Such a logical partition might be backed by actual in existence and allocated infrastructure resources. For example, a pool might partition (e.g., allocate) 100 GBytes of an actual 1 Terabyte storage device. Additionally or alternatively, a logical partition might be provisionally backed by prophetically allocatable infrastructure resources. For example, a pool might assume an allocatable amount of computer memory that could be allocated from a prophetically-available memory footprint.

Various ones of the viability checks store their findings as agent configuration metadata 242 and/or as cluster profile metadata 249. Once such viability checks have been performed and their respective findings stored, a generate step is surmounted (operation 250), which generation results in a viable cluster configuration. In some cases, a particular profile is further vetted (e.g., via capability headroom processor 252) to be sure the advertised cluster configuration 253 has enough headroom to account for any needed expandability.

The techniques of FIG. 2B serve to vet a computing resource pool against requirements and constraints, and such techniques can be used by various container orchestration-specific implementations.

Further details regarding general approaches to bring-up and maintenance of data management applications are described in U.S. patent application Ser. No. 18/819,997 titled “ZERO-CODE ADMINISTRATION OF DATA MANAGEMENT FOR CONTAINERIZED WORKLOADS” filed on Aug. 29, 2024.

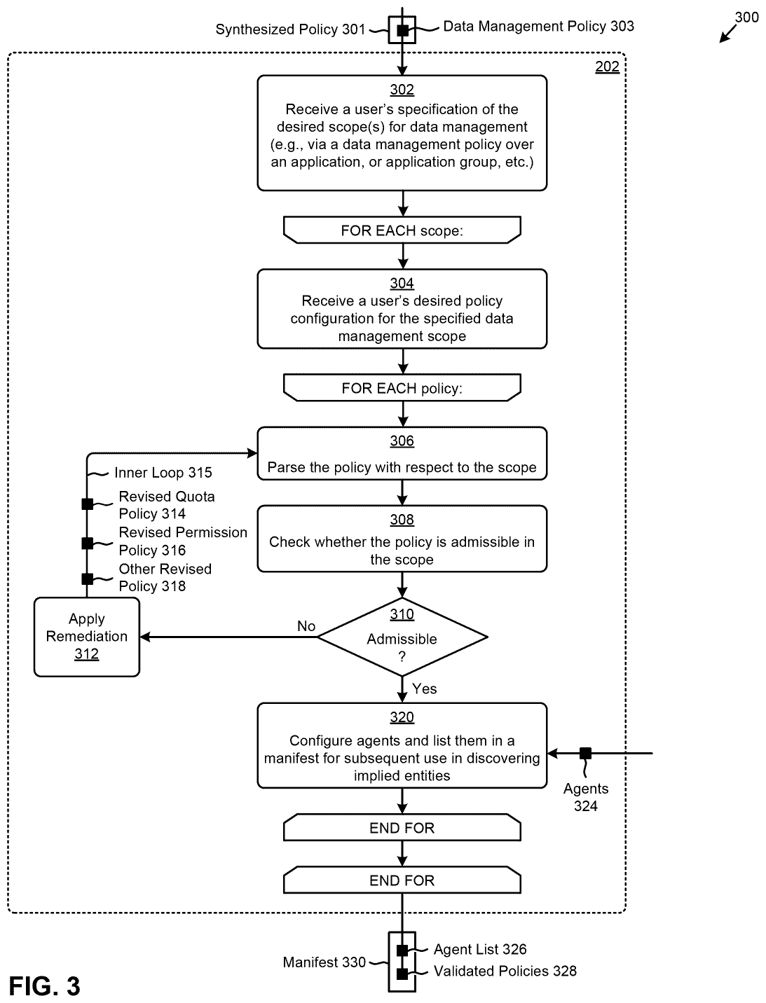

FIG. 3 shows an automated policy admission technique as used in systems that implement zero-code administration of containerized data management workloads. As an option, one or more variations of policy admission technique 300 or any aspect thereof may be implemented in the context of the architecture and functionality of the embodiments described herein and/or in any environment.

The figure is being presented to illustrate one possible technique for implementing the function of step 202 from FIG. 2A. More specifically the figure as a whole is being presented to teach how to generate validated policies based on receipt of a declarative no code configuration of a desired state of a subject container orchestration system.

As shown, the steps (e.g., step 302, step 304, step 306, step 308, decision 310, and step 320) implement merely one embodiment for automated generation of validated policies and discovery and/or automated definition of entities.

The automated policy admission technique 300 involves breaking down a user-specification into applicable scopes and applicable policies within that scope, as well as determining the admissibility and any needed remediation of a policy. Furthermore, the shown automated policy admission technique 300 is able to accept admissible policies, possibly after any needed remediation, and use the semantics of that policy in order to discover implied entities. Such discovery might involve use of specially configured instances of agents 324, which are configurable with respect to any particular policy.

The flow begins when a DevOps person expresses (e.g., through a user interface) a variety of data protection needs in a manner such that a data management intent language interpreter and/or some sort of policy synthesis engine is able to take in the expressed data protection intents and synthesize those needs and intents into a synthesized policy 301, which in turn comprises a data management policy 303.

As an example, a particular DevOps person who is not necessarily skilled in information technology can express data protection needs at a high level of abstraction such as “Even after a disaster, I need to be able to restore my data to be the same as it was one hour before the disaster”, and then rely on operations of the aforementioned data management intent language interpreter and/or any number of policy synthesis operation(s) to be able to define and/or configure a corresponding data management function (e.g., the function of a data management application or the function of a portion of a data management application).

Further details regarding general approaches to policy observation, policy synthesis and use of expressed intents are described in U.S. patent application Ser. No. 18/819,997 titled “ZERO-CODE ADMINISTRATION OF DATA MANAGEMENT FOR CONTAINERIZED WORKLOADS”, filed on Aug. 29, 2024, which is hereby incorporated by reference in its entirety.

As used herein, the term “data management application” and the term “data management function” are used interchangeably with the understanding that a data management application can implement a single data management function, or can implement a series of data management functions. Moreover, a single data management function can be, and indeed might need to be, implemented across multiple data management applications that interoperate between themselves to carry out the data management function or functions.

As used herein, data protection needs are expressions of desired behavior of a collection of Kubernetes pods that run in a container orchestration environment.

In one particular flow, after receipt of a user's specification of one or more desired scopes for some particular data management capability (e.g., application-wide scope, application group scope, etc.), an outer loop pertaining to each scope and an inner loop pertaining to each policy within a particular scope is executed. That is, for each scope, step 304 serves to receive and process a user's desired policy configuration. In some cases, one particular scope may have multiple applicable policies, in which case inner loop 315 pertaining to each policy is entered and the policy is considered with respect to its scope (step 306 and step 308).

After such consideration, decision 310 is taken so as to determine if the user's desired policy configuration is in fact admissible given a set of constraints, which constraints might derive from the underlying infrastructure. If the policy is deemed to be not admissible (the “No” branch of decision 310), then processing moves to various forms of remediation to revise the policy in a manner that brings the policy into admissibility with respect to the underlying infrastructure. Strictly as an example, one way to apply remediation (step 312) might involve revising a quota (e.g., the shown revised quota policy 314), or might involve revising a permission (e.g., the shown revised permission policy 316), or might involve some other policy parameter (e.g., the shown other revised policy 318).

In such cases of remediation, the inner loop will steer processing such that the revised policy, that is the policy that has been remediated, is again parsed (step 306), and again checked as to whether the policy is admissible within the corresponding scope. If the answer from decision 310 is yes, then the “Yes” branch of decision 310 is taken and any one or more agents 324 are configured (step 320). The result of completing both the inner loop and the outer loop is that a manifest 330 comprising an agent list 326 and any number of validated policies 328 are codified and provided to downstream processing. As can be understood, such downstream processing can carry out corresponding functions based on the understanding or assumption that the policies present in the manifest have in fact been validated (e.g., against the infrastructure).

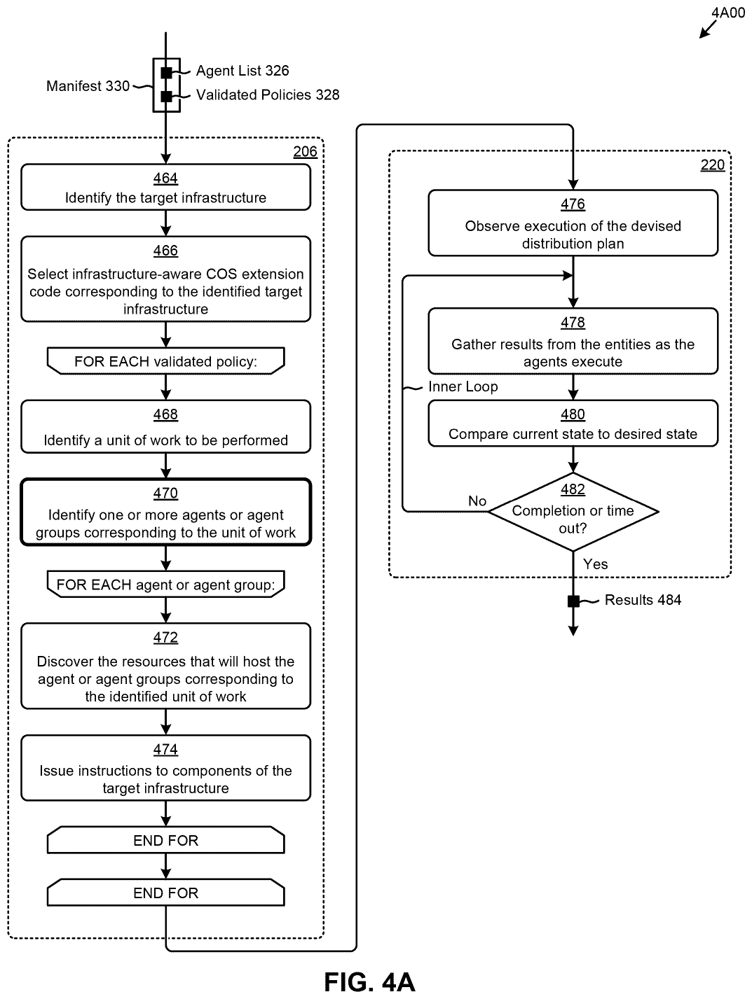

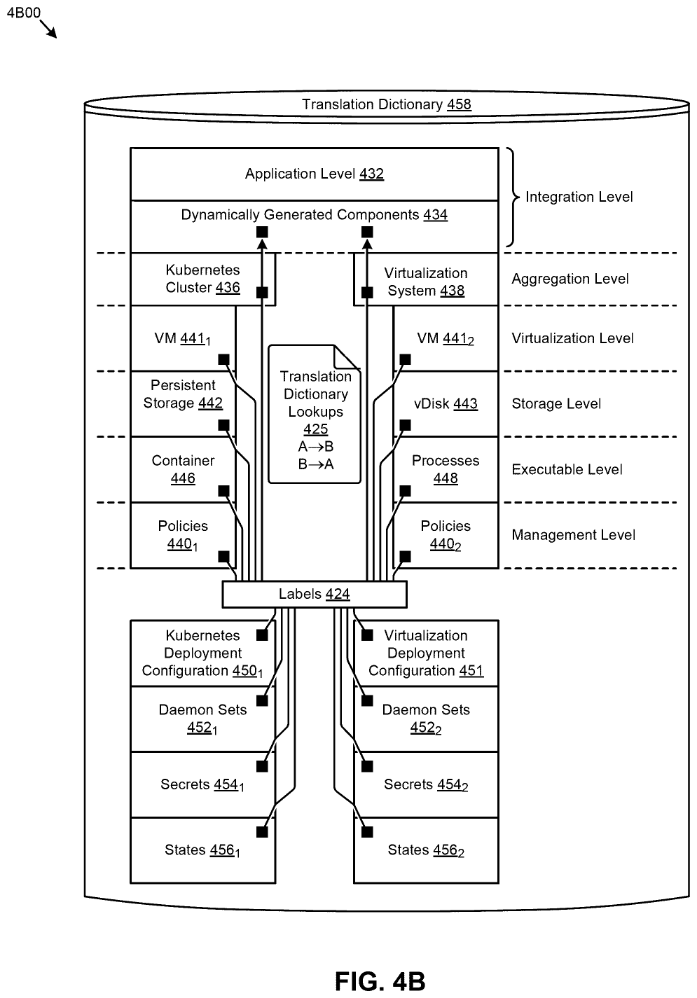

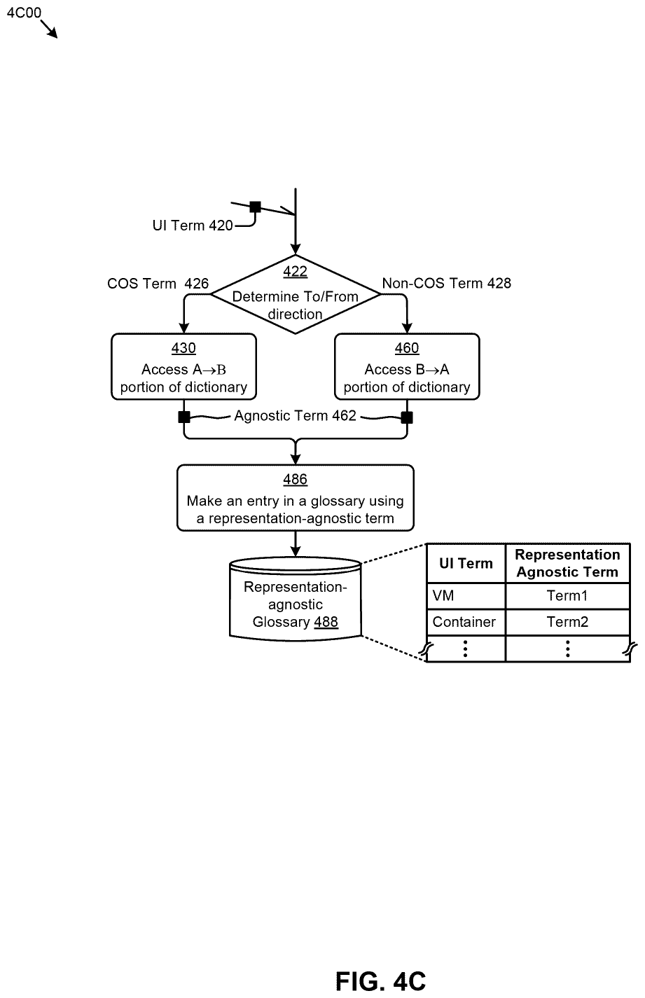

The foregoing presentation of FIG. 3 pertains to merely some possible embodiments and/or ways to implement a policy admission technique. Many variations are possible, for example, the policy admission technique as comprehended in the foregoing can be implemented in any environment, one example of which is shown and described as pertains to FIG. 4A.

FIG. 4A shows a computer-implemented configuration change technique as used in systems that implement zero-code administration of containerized data management workloads. As an option, one or more variations of computer-implemented configuration change technique 4A00 or any aspect thereof may be implemented in the context of the architecture and functionality of the embodiments described herein and/or in any environment.

This figure is being presented to illustrate possible implementations of the aforementioned downstream processing. More specifically, this figure is being presented to illustrate how a declarative no code application configuration can be mapped into operations or instructions (e.g., stop 474) that, when successfully carried out, bring the system to a desired state. In many situations, including the situations contemplated in FIG. 4A, the desired state might be approached or achieved as a result of traversal through many iterations, each of which iteration performs some comparison of a current state as compared with the desired state. In the event that there is some difference between the current state and the desired state, further iterations carry out further steps or operations that are able to achieve the intended or desired state. This is shown and described with respect to step 220, which is discussed in detail in subsequent paragraphs.

As shown, the left side of FIG. 4A depicts an automated flow that implements mapping declarative no code application configuration intents into low level operations that achieve the intended state in the underlying infrastructure. This automated flow is one possible implementation of step 206 as depicted in FIG. 2A. It can be seen that the flow receives a manifest 330, possibly as a result of processing through the flow of FIG. 3. Then the automated flow executes step 464, which is configured to be able to identify aspects of, or the type of infrastructure. Upon having information pertaining to the target infrastructure, processing continues to step 466, which is configured to select infrastructure-aware container orchestration system extensions that correspond to the identified target infrastructure.

Having such identification of the infrastructure as well as corresponding infrastructure aware extensions, each of the validated policies in the manifest 330 can be interpreted to the extent that the units of work to be performed (step 468), as well as any one or more agents or agent groups (step 470) that correspond to the identified unit of work. A manifest of these agents, are made available to an inner iterator (e.g., the FOR EACH agent or agent group iterator) over steps that discover resources needed to host the agent or agent group (step 472) and then issues instructions to components of the target infrastructure (step 474) so as to achieve the desired state of the infrastructure that meets or exceeds what is needed to implement and/or enforce the validated policy.

Strictly as one example, suppose a validated policy refers to a replication factor. In such a case, if the replication factor was desired to be increased, then the intended state of the underlying infrastructure might involve addition of storage resources to hold the replicated data. Continuing with this example, it might turn out that the addition of storage resources to hold the replicated data is on a different node of some underlying cluster. Alternatively, and again continuing with this same example, it might turn out that the addition of storage resources to hold the replicated data are storage resources that are in a different cluster within some availability zone. Such infrastructure determinations (e.g., provision of storage resources in the same cluster or, alternatively, provision of storage resources in a different cluster in an adjacent availability zone) might be determined based on some infrastructure rules, or might be based on some intervention by an IT person.

Now, given that instructions have been issued to components of the target infrastructure (e.g., via step 474) processing moves to the automated flow shown on the right side of FIG. 4A, which is a possible implementation of decision 220 of FIG. 2A. More specifically the automated flow beginning with step 476 and ending with decision 482 includes an inner loop and processing steps that are configured to both (1) gather conditions and/or status of the infrastructure (step 478) as well as another set of processing steps to (2) compare the current observed state to the desired state. The differences between the current observed state and the desired state (if any) (step 480) are passed as inputs to decision 482. The inner loop can cycle through the aforementioned inner loop steps any number of times until decision 482 determines that the desired state has been reached or, alternatively, that some timeout has expired. In the case that the desired state has been reached, then the “Yes” branch of decision 482 is taken and results 484 are codified for presentation to downstream processing.

To further explain, and to refer specifically to a Kubernetes-based environment that supports containerized data management workloads, the user might request desired states of a cluster configuration using particular terms or parameters or units (e.g., requested CPU demands, requested storage demands, etc.) that are pertinent to a particular subject containerized data management workload and/or pertinent to infrastructure considerations (e.g., replication factor requirements, candidate resource pools, policy constraints, storage regulations, candidate availability zones, etc.). Such terms or parameters or units might be used to make assessments, and possibly to produce feedback as guidance to a Kubernetes cluster administrator.

Now, it is well known that there are many situations where the foregoing terms or parameters or units are semantically different as between systems and/or deployments. One way to deal with situations where units and terms are semantically different is to reconcile said terms using a dictionary. Such a dictionary is shown and discussed as pertains to FIG. 4B. Furthermore, techniques for using such a dictionary are discussed as pertains to FIG. 4C.

FIG. 4B shows an automated dictionary-based translation facility as used in systems that implement zero-code administration of containerized data management workloads. As an option, one or more variations of dictionary-based translation facility 4B00 or any aspect thereof may be implemented in the context of the architecture and functionality of the embodiments described herein and/or in any environment.

The translation dictionary lookups 425 such as can be employed in an automated dictionary-based translation facility (e.g., using translation dictionary 458) operate by taking as an input, specifically an input term of a first environment (e.g., a Kubernetes term) and translating it into an output term of a second environment (e.g., a virtualization system term). This is shown as A®B. Additionally or alternatively, the automated dictionary-based translation facility is able to perform a reverse lookup by taking as an input a term of the second environment (e.g., a virtualization system term) and translating it into an output term of the first environment, shown as B®A. There can be many terms and translations, only some examples of which are shown in FIG. 4B. Accordingly, Table 1 is presented strictly for illustrative purposes. Other terms, and other environments, and other translations are possible.

TABLE 1
Example term-to-term translations

| | Kubernetes | Virtualization |
|---|---|---|
| Semantic | Environment Term | System Term |
| Container Orchestration | Kubernetes | Virtualization |
| System Executable | Cluster 436 | System 438 |
| Unit Aggregation | | |
| Virtualization Unit | VM 441₁ | VM 441₂ |
| Non-volatile Storage | Persistent Storage 442 | vDisk 443 |
| Executable Unit | Container 446 | Processes 448 |
| Management Entities | Policies 440₁ | Policies 440₂ |
| Deployment Configuration | Kubernetes Deployment | Virtualization |
| | Configuration | System |
| | 450₁ | Deployment |
| | | Configuration 451 |
| Daemon | Daemon Sets 452₁ | Daemon Sets 452₂ |
| Encryption/Decryption Secrets | Secrets 454₁ | Secrets 454₂ |
| Stateful Variables | States 456₁ | States 456₂ |

Also shown in FIG. 4B is a technique for labeling. In this particular embodiment, a term might be given one or more labels 424, which labels might refer to a name of an environment (e.g., label_K=“Kubernetes” and/or label_D=“Distribution 20200101”. A label can apply to any term or level. For example, and as shown, a label can be applied to any one or more dynamically generated components 434. After a label is applied such as to an executable component, it survives even when one or more of such executable components are integrated into a data management application (e.g., such as might occur at application level 432).

Any one or more of the foregoing automated dictionary-based translation facilities can be used, in whole or in part, in any environment and/or for any purpose. In fact, some implementations map different environment-specific variables (e.g., pertaining to a Kubernetes environment, or pertaining to a virtualization system environment) into an agnostic term (e.g., an environment-agnostic term or a representation-agnostic term). This is shown and described as pertains to FIG. 4C.

FIG. 4C shows a dictionary-enabled representation-agnostic term generation facility 4C00 as used in systems that implement zero-code administration of data management for containerized workloads.

The figure is being presented to illustrate how different environment-specific variables (e.g., pertaining to a Kubernetes environment or pertaining to a virtualization system environment) can be translated into an agnostic term 462 (e.g., an environment-agnostic term or a representation-agnostic term). This particular embodiment exemplifies translations to/from either a container orchestration system term (e.g., COS term 426) or a non-orchestration system term (e.g., non-COS term 428) into an agnostic term. It does so by first determining the origin of the UI term 420 (e.g., a COS term or a non-COS term), and then accessing a translation dictionary either in an A-to-B fashion (step 430) or in a B-to-A fashion (step 460). The result of the lookup is a representation-agnostic term that can be used in downstream processing. In some cases, terms that are used in a particular context are entered (step 486) into a glossary (e.g., representation-agnostic glossary 488). The language of the representation agnostic terms is arbitrary. That is, such representation-agnostic terms need not be human readable.

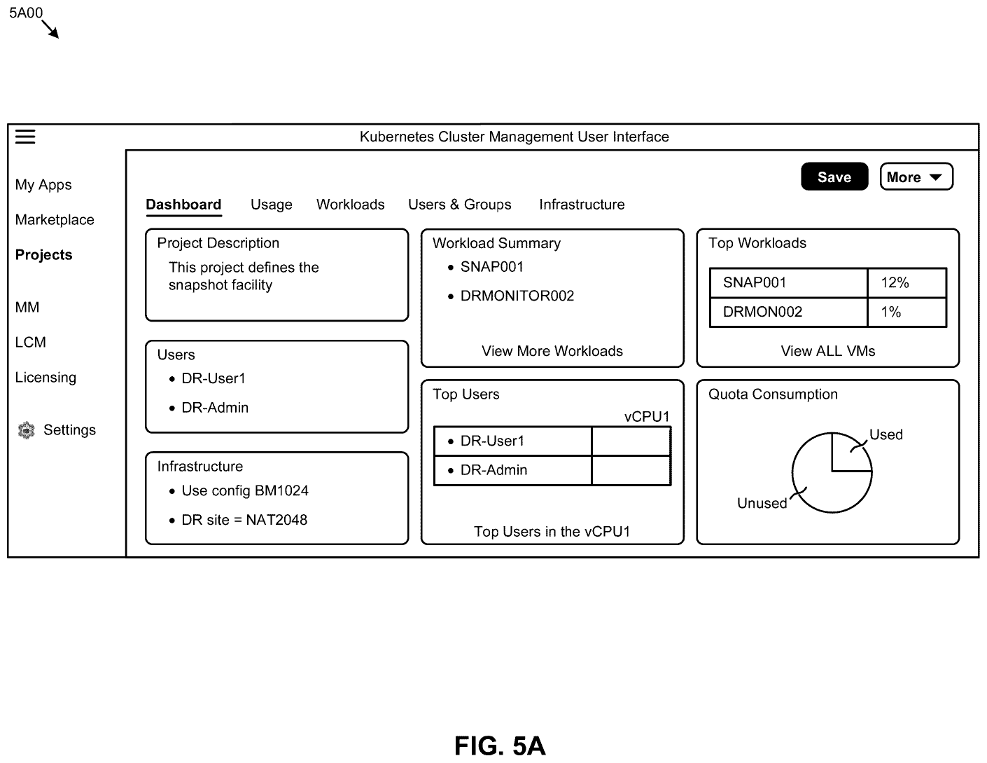

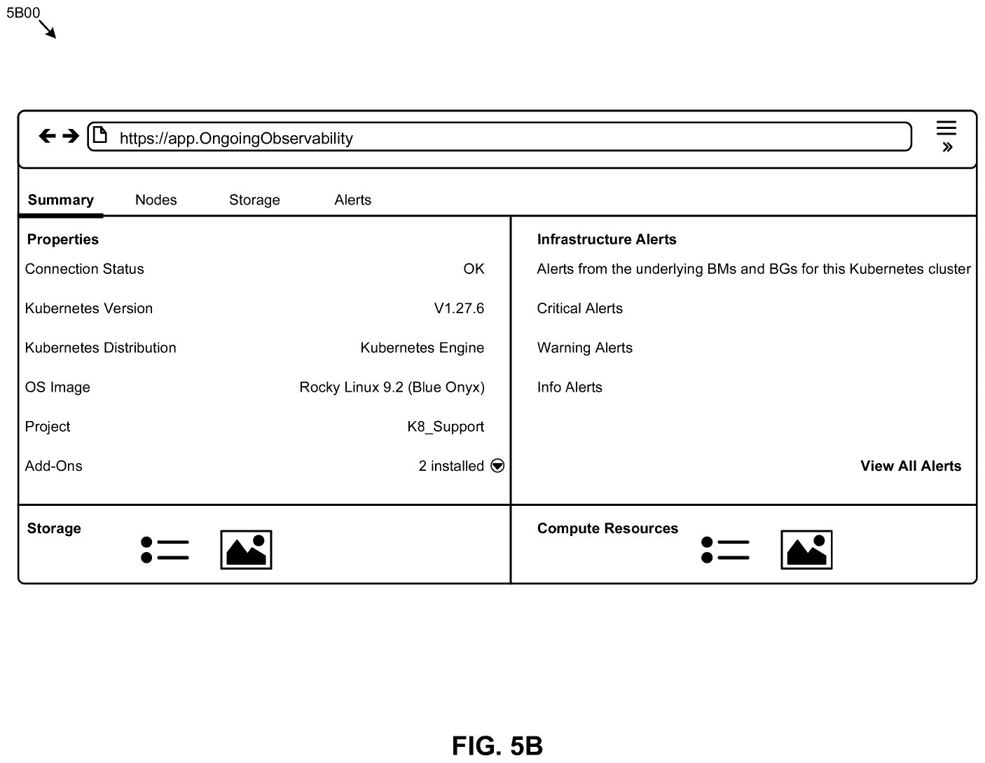

The foregoing discussions of FIG. 4B and FIG. 4C pertain to merely some possible embodiments and/or ways to generate representation-agnostic terms that are in turn used in defining executable entities (e.g., an executable container, a Kubernetes cluster, a virtual machine, a Kubernetes pod, resources and/or resource pools, etc.). Many variations are possible. For example, a tool for semi-automated Kubernetes cluster resource pool definitions can be implemented in any environment and/or can use any of a variety of user interfaces, examples of which user interfaces are shown and described as pertains to FIG. 5A and FIG. 5B.

FIG. 5A shows a first data management application configuration user interface as used in systems that implement zero-code administration of containerized data management workloads. As an option, one or more variations of data management application configuration user interface 5A00 or any aspect thereof may be implemented in the context of the architecture and functionality of the embodiments described herein and/or in any environment.

This embodiment depicts an option for a Kubernetes cluster management user interface having a project dashboard. The project dashboard provides a way for a DevOps person to monitor performance and other characteristics of a Kubernetes-based data management application and/or its underlying infrastructure.

As shown, the dashboard includes options to navigate to informational screens (e.g., screens pertaining to “Usage”, screens pertaining to “Workloads”, screens pertaining to “Users & Groups”, and screens pertaining to “Infrastructure”). As such, a DevOps person, using only GUI widgets (e.g., without the need for having the DevOps person do any coding) can monitor performance and other characteristics of a Kubernetes-based data management application and/or its underlying infrastructure. The information shown in the dashboard is presented merely for purposes of illustration and is not intended to limit the scope of the embodiments.

As an option, one or more variations of project dashboard graphical user interface and/or any underlying data management and/or application management techniques or any aspect thereof may be implemented in the context of the architecture and functionality of the embodiments described herein and/or in any environment. Furthermore, the user interface of FIG. 5A can be extended to facilitate no-code administration of a data management application. One such extension is shown and described as pertains to FIG. 5B.

FIG. 5B shows a second data management application configuration user interface as used in systems that implement zero-code administration of containerized data management workloads. As an option, one or more variations of data management application configuration user interface 5B00 or any aspect thereof may be implemented in the context of the architecture and functionality of the embodiments described herein and/or in any environment.

The shown graphical user interface offers a DevOps person or a K8 administrator a visual depiction of an existing deployment. Further, the shown graphical user interface offers a DevOps person or a K8 administrator a widget-based profiling screen for configuring infrastructure alerts (e.g., “Critical Alerts”, “Warning Alerts”, etc.). As shown, this profiling screen includes GUI widgets so as to addresses the “no code” concept whereby a DevOps person can interact with profiling screen and/or other screens or GUIs so as to provide desired observability instrumentation.

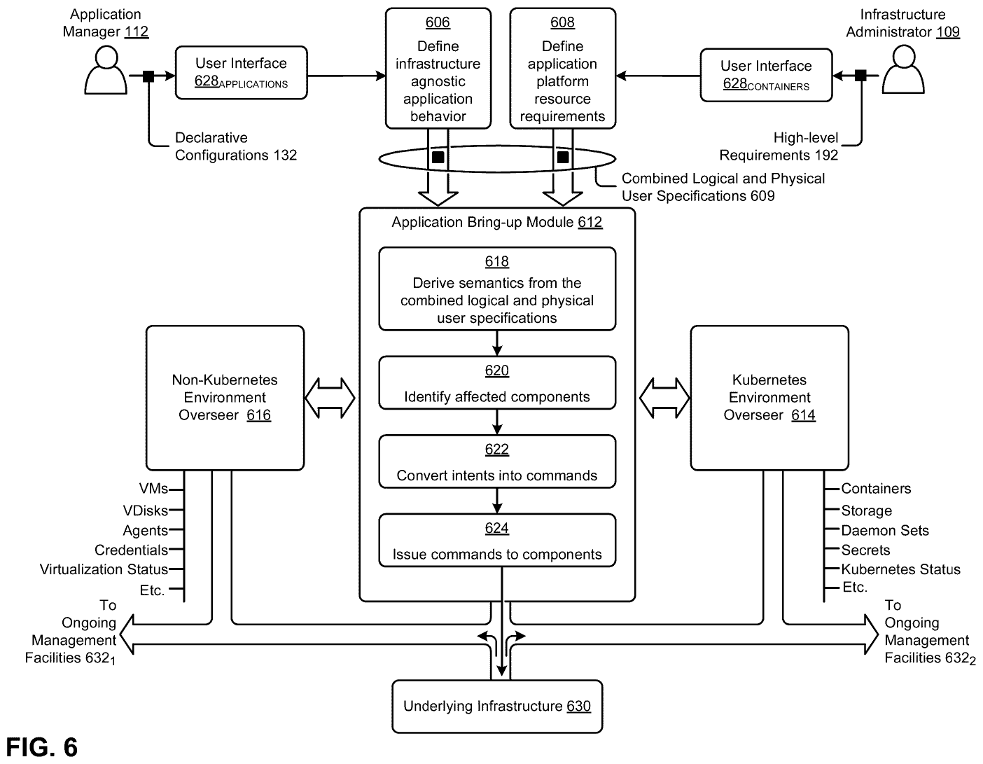

The foregoing presentation of the user interfaces of FIG. 5A and FIG. 5B pertains to merely some possible embodiments and/or ways to implement data management application configuration user interfaces. Many variations are possible, for example, the data management application configuration user interfaces as comprehended in the foregoing can be implemented in any environment, one example of which is shown and described as pertains to FIG. 6.

FIG. 6 shows a data management application bring-up module that implements aspects of zero-code administration of containerized data management workloads. As an option, one or more variations of data management application bring-up module or any aspect thereof may be implemented in the context of the architecture and functionality of the embodiments described herein and/or in any environment.

FIG. 6 is being presented to illustrate one possible way that an application manager 112 and an infrastructure administrator 109 can use respective user interfaces (e.g., user interface 628_{APPLICATIONS}, and user interface 628_{CONTAINERS}) and/or otherwise cooperate together to marshal the bring-up of self-service Kubernetes workloads. More specifically, FIG. 6 is being presented to show how outputs of the procedures underlying defining infrastructure agnostic application behavior (step 606) when combined with outputs of the procedures underlying defining application platform resource requirements (step 608) are combined to form the shown combined logical and physical user specifications 609. FIG. 6 is further being presented to illustrate that declarative configurations 132 provided by application manager 112, in combination with high-level requirements 192 provided by infrastructure administrator 109, are combined and formatted into data structures that are used as inputs to the shown application bring-up module 612.

Still further, FIG. 6 is being presented to illustrate that various nouns and verbs pertaining to a Kubernetes environment are in some ways identical and/or in some ways similar and/or in some ways distinct or mutually exclusive with respect to a non-Kubernetes environment (e.g., the portions of the host infrastructure that does not include components of the Kubernetes environment). Even still further, FIG. 6 is being presented to illustrate that upon and/or after bring-up, variously-configured overseer modules (e.g., Kubernetes environment overseer 614 and non-Kubernetes environment overseer 616) interact on an ongoing basis with the underlying infrastructure 630 (e.g., storage infrastructure 629) and any one or more ongoing management facilities (e.g., ongoing management facilities 6321, ongoing management facilities 6322).

Various terms are associated with, and in some cases, can serve to define a particular environment. Strictly for purposes of illustration, Table 2 is presented hereunder.

TABLE 2

| Environment Type | Terms |
|---|---|
| Kubernetes Environment | Containers, storage, daemon |
| | sets, secrets, Kubernetes status |
| Non-Kubernetes | VMs, vDisks, agents, |
| Environment | credentials, virtualization status |

As shown, the step-wise operation flow of the application bring-up module 612 commences at step 618, wherein any known techniques are applied, singly or in combination, to derive semantics from the combined logical and physical user specifications. The derived semantics in turn, either by virtue of underlying taxonomy of the semantics or due to application of some inferencing techniques, facilitate identification of any number of components of the underlying infrastructure (step 620) that are at least potentially affected during bring-up and ongoing maintenance. Subsequent steps, whether executed singly or in combination, or whether executed in sequence or in parallel, or whether executed by one module or by multiple modules configured into a cooperative arrangement, serve to convert intents into commands (step 622) and then to issue said commands to the affected components (step 624). In an alternative embodiment involving autonomous intent-driven components, the aforementioned subsequent steps are differently configured so as to convert commands into intents (e.g., as a variation of step 622) and then to issue said intents to the affected components (e.g., as a variation of step 624). The affected components subsequently self-configure so as to achieve the expressed intent(s).

Further details regarding involving autonomous, intent-driven components are described in U.S. Patent Publication No. 11,900,172, filed Jul. 29, 2022, and titled, “COMPUTING CLUSTER BRING-UP ON PUBLIC CLOUD INFRASTRUCTURE USING EXPRESSED INTENTS” which is hereby incorporated by reference in its entirety.

The foregoing presentation of FIG. 6 pertains to merely some possible embodiments and/or ways to implement a data management application bring-up module. Many variations are possible, for example, the data management application bring-up module as comprehended in the foregoing can be implemented in any environment.

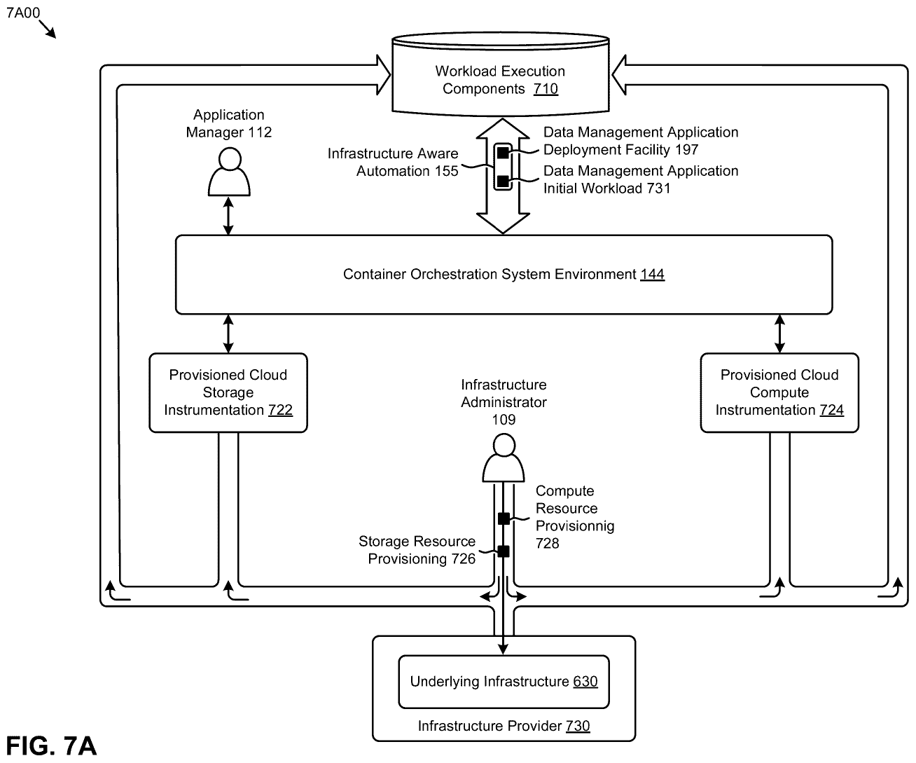

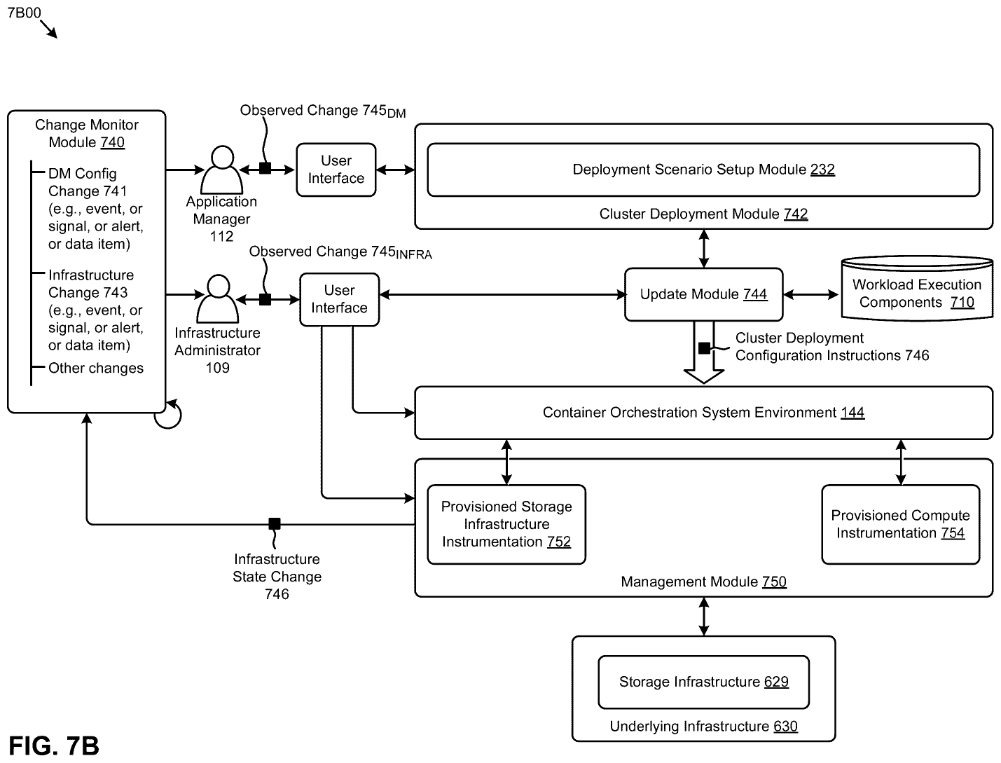

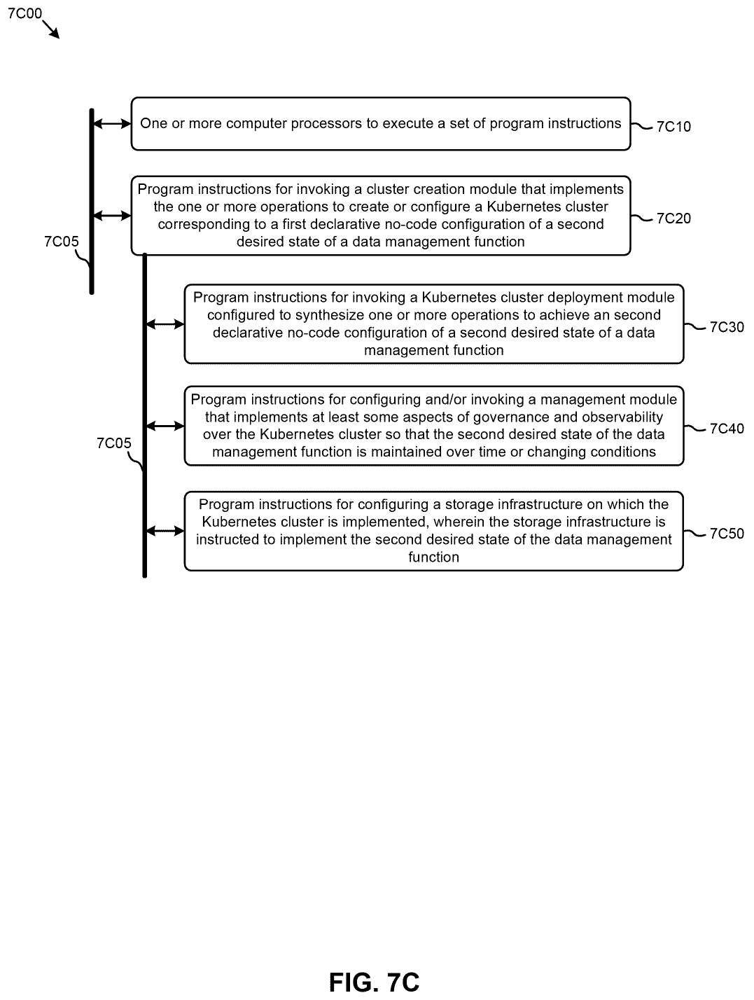

FIG. 7A shows a first example set of system components as used in systems that implement zero-code administration of containerized data management workloads. As an option, one or more variations of system features in FIG. 7A or any aspect thereof may be implemented in the context of the architecture and functionality of the embodiments described herein and/or in any environment.

FIG. 7A is being presented to illustrate how a containerized workload (e.g., a data management application initial workload 731) can be deployed onto a cloud infrastructure in a manner that facilitates gathering ongoing observations and marshalling of infrastructure resources. As is understood by those of skill in the art, workloads (e.g., compute-centric workloads, storage-centric workloads, daemon-type workloads, chron-style workloads, etc.) can be stored in a dormant embodiment (e.g., a file on a storage device as one or more workload execution components 710) until such time as the containerized workload is to be run. In some cases, a workload is self-contained, having all needed code assembled into the workload's dormant embodiment. In other cases, a particular workload relies on components of a particular container environment and/or relies on runtime components (e.g., a container runtime interface, and/or “containerd”, and/or “runc”, etc.) of a particular container orchestration system (e.g., K8s, K3s, Mesos, Nomad, Swarm, etc.). Further, in some cases, a workload might be configured to run in a first cloud (e.g., a public cloud) that hosts a particular first container orchestration system environment 144 over a first underlying infrastructure of a first infrastructure provider 730. Alternatively, and again, strictly as an example, a workload might be configured to run in a second cloud (e.g., a private cloud) that hosts a particular second container orchestration system environment 144 over a second underlying infrastructure of a second infrastructure provider 730.

Regardless of the type of cloud and/or regardless of the particular container orchestration system in use, an infrastructure administrator 109 can handle at least the initial compute resource provisioning 728 and/or at least the initial storage resource provisioning 726. In some cases, the compute resource provisioning 728 includes establishment of provisioned cloud compute instrumentation 724. Similarly, the storage resource provisioning 726 includes establishment of provisioned cloud storage instrumentation 722. Such instrumentation can be accessed and/or controlled by whatever agents might be running in the container orchestration system environment 144. In some cases, the agents present in the container orchestration system environment can be specified and/or controlled by a DevOps person.

FIG. 7B shows a second example set of system components 7B00 as used in systems that implement zero-code administration of containerized data management workloads. The figure is being presented to illustrate one possible embodiment, wherein the various functions needed for realization of a system that implements zero-code administration of containerized data management workloads are implemented in (or as) a set of modules that interoperate cooperatively to observe and respond to ongoing use of infrastructure resources when running self-service Kubernetes workloads.

To explain, note that the system has a change monitoring module (e.g., the shown change monitor module 740), and more particularly note that both the application manager 112 and the infrastructure administrator 109 are able to be responsive to any observed changes in the system. As shown, various changes in the system might arise from either or both (1) a change in the infrastructure (e.g., a node is removed or added), and/or (2) a change in some aspect that influences the desired behavior of the particular data management function. More particularly, application manager 112 can define or interpret a change (e.g., observed change 745_{DM}) and then interact (e.g., via a user interface) with a running cluster deployment module 742. Similarly, infrastructure administrator 109 can define or interpret an infrastructure change (e.g., observed change 745 INFRA) and then interact (e.g., via a user interface). In either or both cases, the user can interact with any one or more of, (1) a cluster deployment facility (e.g., a running cluster deployment module 742), (2) a management facility (e.g., management module 750, and/or (3) any one or more components that comprise or are made available for use within an orchestration system environment (e.g., container orchestration system environment 144) and/or (4) a cluster creating facility (e.g., shown in FIG. 7B as update module 744). Functionality of such a cluster creating facility as suggested by its presence on this listing can be used for example, in situations where there are new components (e.g., a new observation facility or a new type of node) such that the cluster needs to be reconstituted with previously not considered componentry. More particularly, in situations where there are new components, the cluster creation module can generate instructions (e.g., cluster deployment configuration instructions 746) which in turn are used by either or both, (1) components of the container orchestration system environment, and/or (2) the aforementioned management facility, and/or (3) componentry of the underlying infrastructure itself, possibly including storage infrastructure.

As such, a system for observing and governing ongoing use of infrastructure resources when running self-service Kubernetes-based data management workloads such as depicted by FIG. 7B can be partitioned into the modules as depicted. Of course, the partitioning into the shown modules is merely for illustrative purposes—other partitionings are possible. For example, different partitioning might be felicitous based on the particular container orchestration system environment. More particularly, functions that are implemented by (for example) the change monitor module might instead be implemented in the update module 744 and vice-versa.

The foregoing presentation of FIG. 7B pertains to merely some possible embodiments and/or ways to implement system features. Many variations are possible, for example, the systems and features as comprehended in the foregoing can be implemented in any environment, possibly involving different or additional embodiments, one example of which is shown and described as pertains to FIG. 7C.

FIG. 7C depicts system 7C00 as an arrangement of computing modules that are interconnected so as to operate cooperatively to implement certain of the herein-disclosed embodiments. The shown partitioning of system 7C00 is merely illustrative and other partitions are possible.

Variations of the foregoing may include more or fewer of the shown modules. Certain variations may perform more or fewer (or different) steps and/or certain variations may use data elements in more, or in fewer, or in different operations. Still further, some embodiments include variations in the operations performed, and some embodiments include variations of aspects of the data elements used in the operations.

FIG. 7C depicts a block diagram of a system to perform certain functions of a computer system. As an option, system 7C00 may be implemented in the context of the architecture and functionality of the embodiments described herein. Of course, however, system 7C00 or any operation therein may be carried out in any desired environment. The system 7C00 comprises at least one processor and at least one memory, the memory serving to store program instructions corresponding to the operations of the system. As shown, an operation can be implemented in whole or in part using program instructions accessible by a module. The modules are connected to communication path(s) 7C05, and any operation can communicate with any other operations over communication path(s) 7C05. The modules of the system can, individually or in combination, perform method operations within system 7C00. Any operations performed within system 7C00 may be performed in any order unless as may be specified in the claims. The shown embodiment implements a portion of a computer system, presented as system 7C00, comprising one or more computer processors to execute a set of program code instructions (module 7C10) and modules for accessing memory to hold program code instructions to perform: invoking a cluster creation module that implements the one or more operations to create or configure a Kubernetes cluster corresponding to a first declarative no-code configuration of a first desired state of a data management function (module 7C20); invoking a Kubernetes cluster deployment module configured to synthesize one or more operations to achieve a second declarative no-code configuration of a second desired state of the data management function (module 7C30); invoking a management module that implements at least some aspects of governance and observability over the Kubernetes cluster so that the desired state of the data management function is maintained over time or changing conditions (module 7C40); and configuring a storage infrastructure on which the Kubernetes cluster is implemented, wherein the storage infrastructure is instructed to implement the second desired state of the data management function (module 7C50).

The systems and techniques of FIG. 7A, FIG. 7B and FIG. 7C might rely on, at least in part, deployment of modules that comprehend container orchestration-specific vernacular such that, for example, a series of predefined Kubernetes-specific application programming interfaces can be used to create, register and maintain one or more desired Kubernetes clusters to handle the particular data management application. Moreover, the foregoing systems and techniques of FIG. 7A, FIG. 7B and FIG. 7C pertain to merely some possible embodiments and/or ways to implement system features. Many variations are possible, for example, the systems and features as comprehended in the foregoing can be implemented in any environment, possibly involving different or additional embodiments, some examples of which are shown and described hereunder.

### ADDITIONAL EMBODIMENTS OF THE DISCLOSURE

### Additional Information

Strictly as a convenience, Table 3 is presented as an example Kubernetes cluster glossary.

TABLE 3
Glossary of components that make up a hypothetical Kubernetes cluster

| Term | Elucidation |
|---|---|
| Kubernetes | An open-source container orchestration |
| cluster | platform that manages, deploys, and scales |
| | containerized applications across multiple nodes. |
| Node | A machine that is part of the cluster and runs pods. |
| | Nodes can be virtual or physical machines. |
| Pod | The smallest and most basic unit of deployment |
| | in Kubernetes. A pod consists of one or more |
| | containers that share the same network |
| | and storage resources. |
| Container | A lightweight and isolated environment that runs |
| | an application and its dependencies. Containers are |
| | based on images that specify the application |
| | code and configuration. |
| Control | The set of components that manage the cluster |
| plane | and maintain the desired state. The control plane |
| | consists of the following components: |
| | kube-apiserver: The component that exposes |
| | the Kubernetes API and acts as the front end for the |
| | control plane. It handles requests from users, |
| | clients, and other components. |
| | etcd: The consistent and highly-available key-value |
| | store that stores the cluster data, such as |
| | configuration, state, and metadata. |
| | kube-scheduler: The component that watches |
| | for newly created pods and assigns them to |
| | nodes based on various factors, such as resource |
| | requirements, constraints, affinity, and |
| | availability. |
| | kube-controller-manager: The component that runs |
| | the controller processes that implement the core |
| | logic of Kubernetes. Controllers are responsible |
| | for managing different aspects of the cluster, |
| | such as nodes, pods, services, deployments, |
| | and replica sets. |
| Worker | A node that runs the pods that are the components |
| node | of the application workload. Worker nodes have |
| | the following components: |
| | kubelet: The agent that runs on each node and |
| | communicates with the control plane. It ensures that |
| | the pods and containers are running and |
| | healthy on the node. |
| | kube-proxy: The network proxy that runs on each |
| | node and enables the service abstraction |
| | by forwarding requests to the appropriate pods. |
| | Container runtime: The software that runs and |
| | manages the containers on the node. Examples of |
| | container runtimes are Docker, containerd, and CRI-O. |

As is known in the art, Kubernetes is a portable, extensible, open source platform for managing containerized workloads and services that facilitate both declarative configuration and automation. It has a large, rapidly growing ecosystem. Kubernetes services, support, and tools are widely available and are described in Table 4.

TABLE 4

| Term | Elucidation |
|---|---|
| Cluster Architecture | The architectural concepts behind Kubernetes. |
| Containers | Technology for packaging an application |
| | along with its runtime dependencies. |
| Workloads | Workloads are implemented as one or more |
| | pods, which is/are the smallest deployable |
| | compute object in Kubernetes. A workload |
| | is a higher-level abstraction that helps |
| | administrators refer to one or more Pods |
| | as a unit. |
| Services, Load | Concepts and resources behind networking |
| Balancing, | in Kubernetes. |
| and Networking | |
| Storage | Ways to provide both long-term and |
| | temporary storage to pods in the cluster. |
| Configuration | Resources that Kubernetes provides |
| | for configuring pods. |
| Security | Techniques for keeping the cloud-native |
| | workload secure. |
| Policies | Data structures used for managing security |
| | and best-practices. |
| Scheduling, | In Kubernetes, scheduling refers to making |
| Preemption | sure that pods are matched to nodes so that |
| and Eviction | the kubelet can run them. Preemption is the |
| | process of terminating pods with lower |
| | priorities so that pods with higher priorities |
| | can be scheduled on the nodes. Eviction is |
| | the process of proactively terminating one |
| | or more pods (e.g., in the case that the pods |
| | are executing on resource-starved nodes). |
| Cluster | Lower-level detail relevant to creating |
| Administration | or administering a Kubernetes cluster. |
| Windows in | Term referring to the situation where |
| Kubernetes | Kubernetes constructs are configured to run |
| | Microsoft ® Windows ®. |
| Extending | Different ways to change the behavior |
| Kubernetes | of a Kubernetes cluster. |

### Variations

In some settings, the foregoing advances can be deployed as a control layer that simplifies and brings the full power of enterprise-grade data services so as to manage the entire lifecycle of applications running on Kubernetes. With this advance, an administrator, rather than relying on pure wits to manage through the entire lifecycle of applications running on Kubernetes, can use application-centric, operator-driven storage provisioning and data management services as provided by embodiments of this disclosure. In some cases, the control layer uses pre-existing APIs so that both functionality and observability needs can be addressed from within a Kubernetes cluster (e.g., via an agent), thus enabling a declarative style of data management applications (e.g., snapshotting, replication, disaster recovery) that encompass all types of storage.

On-premises solutions as well as public cloud and/or private cloud and hybrid cloud use cases are supported. Moreover, the foregoing advances simplify management of file shares and object storage from operator-driven environments.

Various references to “the administrator” or “an administrator” have been presented hereinabove. In actual practice an “administrator” can embody any one or more of the following persona:
Persona #1: IT Admin/Prism Admin. Highest-level admin with full infrastructure and tenant access. This persona manages deployments and can set up, configure, and make use of every feature in the platform.
Persona #2: Kubernetes Admin. Manages all entities within a Kubernetes (or alternative) cluster, including all entities in an assigned project, and performs storage/disaster recovery (DR) operations on those.
Persona #3: DevOps Engineer/Kubernetes App User. Manage the day-1 and day-2 operations of applications running on Kubernetes.

### Interactions Between Teams on the Customer Site to Configure Data Protection Services

The foregoing user interfaces and any disclosed functionality supports high quality interactions across the three user personas described above. This accelerates application deployment and management of Day 1 and Day 2 operations for containerized applications. A typical flow for setup, and then ongoing observation and marshalling of infrastructure resources after onboarding a Kubernetes cluster might include interactions by and between teams/user personas such as in the following example steps:
Step 1: IT admin creates a project with NCI cluster resources (compute resources, storage resources and networking resources) allocated to it.
Step 2: IT admin creates users, user groups, access policies and associated roles including a new specialized ‘Kubernetes Admin’ role.
Step 3: IT admin checks for admissibility of the access policies (e.g., whether the demands that derive from a policy are admissible within the footprint of the project and/or within the footprint of the cluster resources). The IT admin optionally enforces (e.g., manually, or via an agent) resource quotas, storage, and governance policies as necessary.
Step 4: Now that infrastructure resources are allocated, Day 0 operations for the Kubernetes Admin(s) includes creating the Kubernetes clusters on supported Kubernetes (or alternative) distributions and onboarding the clusters using supported onboarding tools.
Step 5: Kubernetes Admin installs CSI, NDK DPS (Data Protection Services) add-ons as necessary and provisions VMs to the Kubernetes (or alternative) cluster. Categories/tags can be used to indicate VMs associated with Kubernetes (or alternative) clusters.
Step 6: DevOps teams uses the provisioned Kubernetes clusters to launch applications and uses self-service tools and CRDs to scale and configure Day 2 operations for these applications.
Step 7: While the infrastructure is in use, IT admin gets visibility into newly created Kubernetes (or alternative) clusters and resources (vCPUs, vDisks) attached to them.
Step 8: An IT admin gets access to alerts for monitoring resources, enforcing quotas, and checking on alerts related to specified storage policies.
Step 9: IT admin uses familiar tools like resource pages (as found in certain cluster overseer modules) for finer granular filtering of resources using category key: value pair.

These steps rely in whole or in part on: (1) Provisioning of a reliable, secure and public repository (e.g., the public repository means anyone should be able to download these images without any restriction or rate-limit; (2) Dockerhub implementations; (3) basic IT admin views and workflows; (4) ongoing software upgrades-specifically software updates to achieve and maintain the required versions; (5) creation of ‘Projects’ to carve out infrastructure resources to be used for Kubernetes deployments; (6) assigning users with role-based access control (RBAC); (7) enforcing quotas for resources; (8) support for service accounts to avail of core services; (9) granular RBAC (involving current user account-based RBAC with Kubernetes); (10) support for any certified or custom Kubernetes distribution; (11) enabling a view of resources used by Kubernetes clusters; (12) filtering resources used in Kubernetes clusters using categories (e.g., in a key: value pair implementation); (13) providing visibility into Kubernetes cluster infrastructure; (14) listing of Kubernetes cluster types; (15) proving visibility into infrastructure metadata (e.g., possibly filtered for a specific Kubernetes cluster or for a specific set of Kubernetes clusters using a ‘category’ value to be used in filtering/selection criteria; this supports a use model where an IT admin would want to be able to identify which computing entities are associated with particular namespaces in a Kubernetes cluster so as to be able to use relatable names when communicating with other Kubernetes administrators or others who are in the role of the aforementioned persona); and (16) provide a breakdown of storage used (e.g., for active primary storage, for snapshots, etc.).

In some cases, the foregoing steps rely, in whole or in part on: (1) installation with zero code and minimal interaction (e.g., using a Helm Chart); (2) defining a set of storage classes based on attributes of performance, availability, encryption and compression; (3) isolation of workloads; (4) improvement of resource utilization and availability using topology awareness; (5) provide enhanced security for use during provisioning, deprovisioning, resizing, etc.; (6) use of hypervisor-attached volumes (e.g., to provide enhanced security; (7) support for guest-attached volumes, (8) support for viewing volume health events using (e.g., using monitoring tools); (9) use of snapshot syntax and semantics (e.g., for create, delete, list operations); (10) use for RWO and ROM volumes and RWO, ROM, RWX with files; (11) support for backward compatibility (e.g., support for restore operations using snapshots created using earlier snapshotting versions); (12) all forms of disaster recovery; (13) support for copy data management (CDM); (14) support for workload rebalancing and migration (e.g., between Kubernetes clusters, including between non-Kubernetes clusters); (15) support for backup and restore operations in or by or using Kubernetes clusters and/or non-Kubernetes clusters; (16) deployment of/stateless applications on selected Kubernetes distributions; (17) registration of a Kubernetes cluster as a first-class entity within the control layer; (18) support for on-demand snapshotting of the application to protect application data when required; (19) support for restoring a specified snapshot of the application; (20) set up of scheduled snapshots and retention policies for periodic protection of application data; (21) creation of a replication schedule between two or more Kubernetes clusters (e.g., using async replication to ensure specific RPO and/or specific RTO objectives for business-critical applications; (22) automatically propose/provision a replication schedule between two Kubernetes clusters (e.g., using synchronous replication to ensure zero RPO and near-zero RTO) for mission critical applications; (23) synchronously replicate application configurations via an event-driven method (e.g., so that the two or more participating sites are truly synchronized); (24) support for ongoing synchronization between the two or more participating sites by taking snapshots of the application configuration at periodic intervals; (25) support for failover and failback (e.g., with resources being cleaned up after each operation); (26) capability to instantiate data management applications based on a saved state and/or contents (or metadata) of a snapshot (e.g., to initiate a recovery operation at a secondary cluster); and (27) capability to generate log files.

### System Architecture Overview

### Additional System Architecture Examples

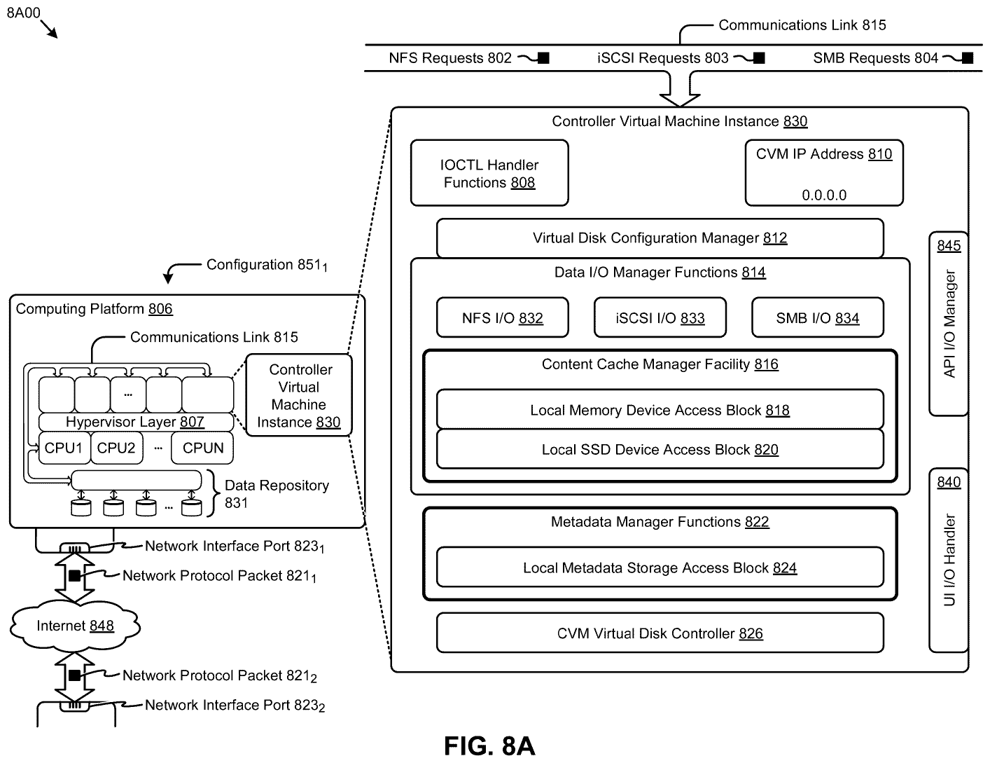

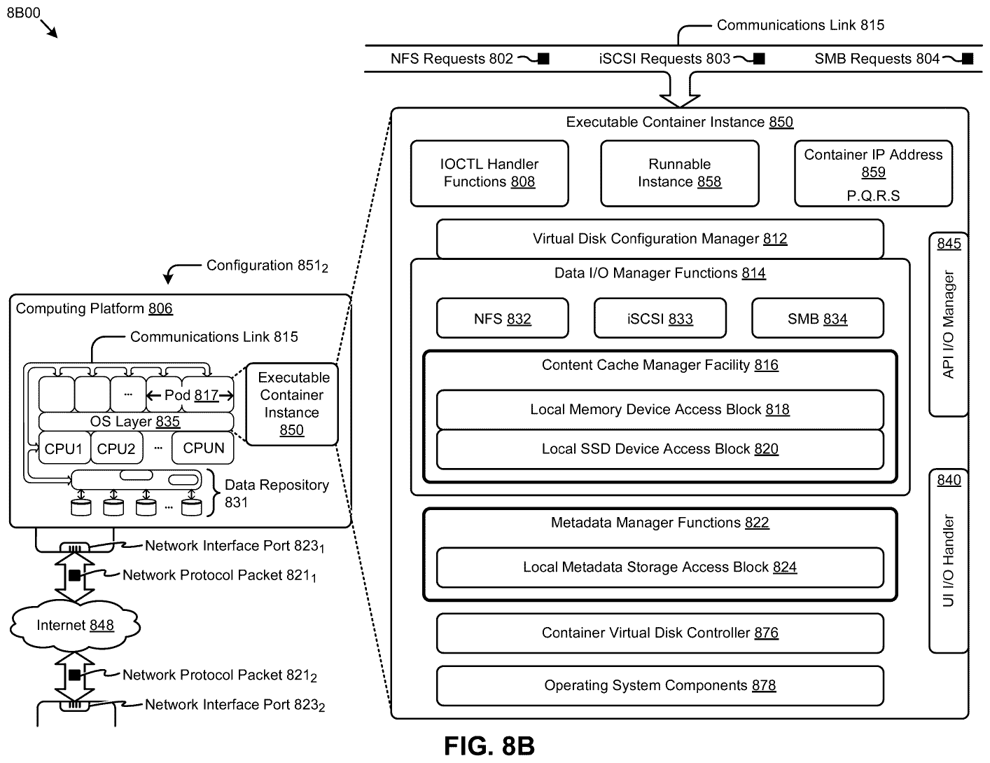

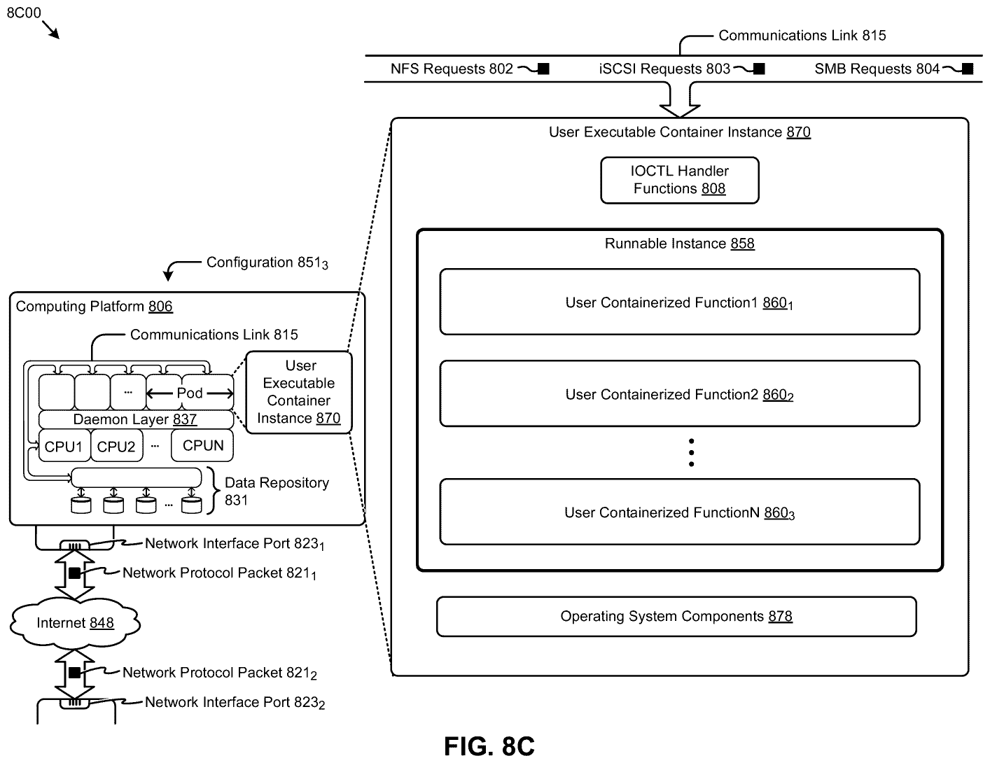

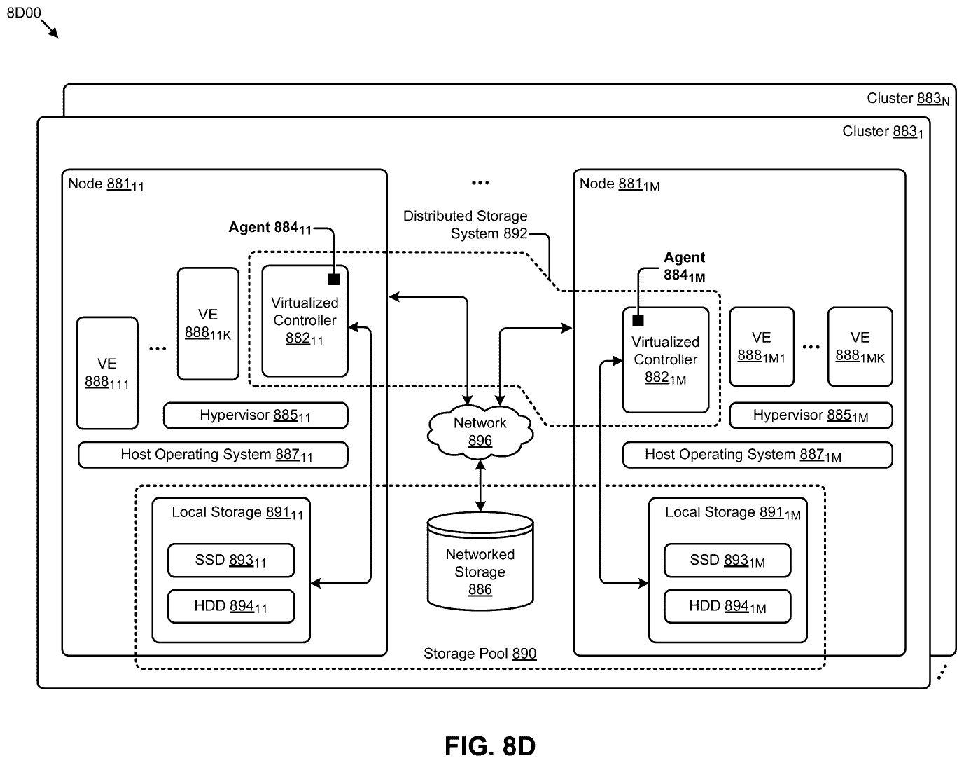

All or portions of any of the foregoing techniques can be partitioned into one or more modules and instanced within, or as, or in conjunction with, a virtualized controller in a virtual computing environment. Some example instances of virtualized controllers situated within various virtual computing environments are shown and discussed as pertains to FIG. 8A, FIG. 8B, FIG. 8C, and FIG. 8D.

FIG. 8A depicts a virtualized controller as implemented in the shown virtual machine architecture 8A00. The heretofore-disclosed embodiments, including variations of any virtualized controllers, can be implemented in distributed systems where a plurality of networked-connected devices communicate and coordinate actions using inter-component messaging.

As used in these embodiments, a virtualized controller is a collection of software instructions that serve to abstract details of underlying hardware or software components from one or more higher-level processing entities. A virtualized controller can be implemented as a virtual machine, as an executable container, or within a layer (e.g., such as hypervisor layer 807). Furthermore, as used in these embodiments, distributed systems are collections of interconnected components that are designed for, or dedicated to, storage operations as well as being designed for, or dedicated to, computing and/or networking operations.

Interconnected components in a distributed system can operate cooperatively to achieve a particular objective such as to provide high-performance computing, high-performance networking capabilities, and/or high-performance storage and/or high-capacity storage capabilities. For example, a first set of components of a distributed computing system can coordinate to efficiently use a set of computational or compute resources, while a second set of components of the same distributed computing system can coordinate to efficiently use the same or a different set of data storage facilities.

A hyperconverged system coordinates the efficient use of compute and storage resources by and between the components of the distributed system. Adding a hyperconverged unit to a hyperconverged system expands the system in multiple dimensions. As an example, adding a hyperconverged unit to a hyperconverged system can expand the system in the dimension of storage capacity while concurrently expanding the system in the dimension of computing capacity and also in the dimension of networking bandwidth. Components of any of the foregoing distributed systems can comprise physically and/or logically distributed autonomous entities.

Physical and/or logical collections of such autonomous entities can sometimes be referred to as nodes. In some hyperconverged systems, computing and storage resources can be integrated into a unit of a node. Multiple nodes can be interrelated into an array of nodes, which nodes can be grouped into physical groupings (e.g., arrays) and/or into logical groupings or topologies of nodes (e.g., spoke-and-wheel topologies, rings, etc.). Some hyperconverged systems implement certain aspects of virtualization. For example, in a hypervisor-assisted virtualization environment, certain of the autonomous entities of a distributed system can be implemented as virtual machines. As another example, in some virtualization environments, autonomous entities of a distributed system can be implemented as executable containers. In some systems and/or environments, hypervisor-assisted virtualization techniques and operating system (OS) virtualization techniques are combined.

As shown, virtual machine architecture 8A00 comprises a collection of interconnected components suitable for implementing embodiments of the present disclosure and/or for use in the herein-described environments. Moreover, virtual machine architecture 8A00 includes a controller virtual machine instance 830 in configuration 8511 that is further described below as pertaining to implementation of such a controller virtual machine instance 830. Configuration 8511 supports virtual machine instances that are deployed as user virtual machines, or controller virtual machines or both. Such virtual machines interface with a hypervisor layer (as shown). Some virtual machines are configured to process storage inputs or outputs (I/O or IO) as received from any or every source within the computing platform. An example implementation of such a virtual machine that processes storage I/O is depicted as 830.

In this and other configurations, a controller virtual machine instance receives block I/O storage requests as network file system (NFS) requests in the form of NFS requests 802, and/or internet small computer system interface (iSCSI) block IO requests in the form of iSCSI requests 803, and/or Samba file system (SMB) requests in the form of SMB requests 804. The controller virtual machine (CVM) instance publishes and responds to an internet protocol (IP) address (e.g., CVM IP address 810). Various forms of input and output can be handled by one or more IO control (IOCTL) handler functions (e.g., IOCTL handler functions 808) that interface to other functions such as data IO manager functions 814 and/or metadata manager functions 822. As shown, the data IO manager functions can include communication with virtual disk configuration manager 812 and/or can include direct or indirect communication with any of various block IO functions (e.g., NFS 832, iSCSI 833, SMB 834, etc.).

In addition to block IO functions, configuration 8511 supports input or output (IO) of any form (e.g., block IO, streaming IO) and/or packet-based IO such as hypertext transport protocol (HTTP) traffic, etc., through either or both of a user interface (UI) handler such as UI IO handler 840 and/or through any of a range of application programming interfaces (APIs), possibly through API IO manager 845.

Communications link 815 can be configured to transmit (e.g., send, receive, signal, etc.) any type of communications packets comprising any organization of data items. The data items can comprise a payload data, a destination address (e.g., a destination IP address) and a source address (e.g., a source IP address), and can include various packet processing techniques (e.g., tunneling), encodings (e.g., encryption), and/or formatting of bit fields into fixed-length blocks or into variable length fields used to populate the payload. In some cases, packet characteristics include a version identifier, a packet or payload length, a traffic class, a flow label, etc. In some cases, the payload comprises a data structure that is encoded and/or formatted to fit into byte or word boundaries of the packet.

In some embodiments, hard-wired circuitry may be used in place of, or in combination with, software instructions to implement aspects of the disclosure. Thus, embodiments of the disclosure are not limited to any specific combination of hardware circuitry and/or software. In embodiments, the term “logic” shall mean any combination of software or hardware that is used to implement all or part of the disclosure.

The term “computer readable medium” or “computer usable medium” as used herein refers to any medium that participates in providing instructions to a data processor for execution. Such a medium may take many forms including, but not limited to, non-volatile media and volatile media. Non-volatile media includes any non-volatile storage medium, for example, solid state storage devices (SSDs) or optical or magnetic disks such as hard disk drives (HDDs) or hybrid disk drives, or random access persistent memories (RAPMs) or optical or magnetic media drives such as paper tape or magnetic tape drives. Volatile media includes dynamic memory such as random access memory. As shown, the detail of controller virtual machine instance 830 includes content cache manager facility 816 that accesses storage locations, possibly including local dynamic random access memory (DRAM) (e.g., through local memory device access block 818) and/or possibly including accesses to local solid state storage (e.g., through local SSD device access block 820).

Common forms of computer readable media include any non-transitory computer readable medium, for example, floppy disk, flexible disk, hard disk, magnetic tape, or any other magnetic medium; compact disk read-only memory (CD-ROM) or any other optical medium; punch cards, paper tape, or any other physical medium with patterns of holes; or any random access memory (RAM), programmable read-only memory (PROM), erasable programmable read-only memory (EPROM), flash memory EPROM (FLASH-EPROM), or any other memory chip or cartridge. Any data can be stored, for example, in any form of data repository 831, which in turn can be formatted into any one or more storage areas, and which can comprise parameterized storage accessible by a key (e.g., a filename, a table name, a block address, an offset address, etc.). Data repository 831 can store any forms of data, and may comprise a storage area dedicated to storage of metadata pertaining to the stored forms of data. In some cases, metadata can be divided into portions. Such portions and/or cache copies can be stored in the storage data repository and/or in a local storage area (e.g., in local DRAM areas and/or in local SSD areas). Such local storage can be accessed using functions provided by local metadata storage access block 824. The data repository 831 can be configured using CVM virtual disk controller 826, which can in turn manage any number or any configuration of virtual disks.

Execution of a sequence of instructions to practice certain embodiments of the disclosure are performed by one or more instances of a software instruction processor, or a processing element such as a central processing unit (CPU) or data processor or graphics processing unit (GPU), or such as any type or instance of a processor (e.g., CPU1, CPU2, . . . , CPUN). According to certain embodiments of the disclosure, two or more instances of configuration 8511 can be coupled by communications link 815 (e.g., backplane, local area network, public switched telephone network, wired or wireless network, etc.) and each instance may perform respective portions of sequences of instructions as may be required to practice embodiments of the disclosure.

The shown computing platform 806 is interconnected to the Internet 848 through one or more network interface ports (e.g., network interface port 8231 and network interface port 8232). Configuration 8511 can be addressed through one or more network interface ports using an IP address. Any operational element within computing platform 806 can perform sending and receiving operations using any of a range of network protocols, possibly including network protocols that send and receive packets (e.g., network protocol packet 8211 and network protocol packet 8212).

Computing platform 806 may transmit and receive messages that can be composed of configuration data and/or any other forms of data and/or instructions organized into a data structure (e.g., communications packets). In some cases, the data structure includes program instructions (e.g., application code) communicated through the Internet 848 and/or through any one or more instances of communications link 815. Received program instructions may be processed and/or executed by a CPU as it is received and/or program instructions may be stored in any volatile or non-volatile storage for later execution. Program instructions can be transmitted via an upload (e.g., an upload from an access device over the Internet 848 to computing platform 806). Further, program instructions and/or the results of executing program instructions can be delivered to a particular user via a download (e.g., a download from computing platform 806 over the Internet 848 to an access device).

Configuration 8511 is merely one sample configuration. Other configurations or partitions can include further data processors, and/or multiple communications interfaces, and/or multiple storage devices, etc. within a partition. For example, a partition can bound a multi-core processor (e.g., possibly including embedded or collocated memory), or a partition can bound a computing cluster having a plurality of computing elements, any of which computing elements are connected directly or indirectly to a communications link. A first partition can be configured to communicate to a second partition. A particular first partition and a particular second partition can be congruent (e.g., in a processing element array) or can be different (e.g., comprising disjoint sets of components).

A cluster is often embodied as a collection of computing nodes that can communicate between each other through a local area network (LAN) and/or through a virtual LAN (VLAN) and/or over a backplane. Some clusters are characterized by assignment of a particular set of the aforementioned computing nodes to access a shared storage facility that is also configured to communicate over the local area network or backplane. In many cases, the physical bounds of a cluster are defined by a mechanical structure such as a cabinet or such as a chassis or rack that hosts a finite number of mounted-in computing units. A computing unit in a rack can take on a role as a server, or as a storage unit, or as a networking unit, or any combination therefrom. In some cases, a unit in a rack is dedicated to provisioning of power to other units. In some cases, a unit in a rack is dedicated to environmental conditioning functions such as filtering and movement of air through the rack and/or temperature control for the rack. Racks can be combined to form larger clusters. For example, the LAN of a first rack having a quantity of 32 computing nodes can be interfaced with the LAN of a second rack having 16 nodes to form a two-rack cluster of 48 nodes. The former two LANs can be configured as subnets, or can be configured as one VLAN. Multiple clusters can communicate between one module to another over a WAN (e.g., when geographically distal) or a LAN (e.g., when geographically proximal).

As used herein, a module can be implemented using any mix of any portions of memory and any extent of hard-wired circuitry including hard-wired circuitry embodied as a data processor. Some embodiments of a module include one or more special-purpose hardware components (e.g., power control, logic, sensors, transducers, etc.). A data processor can be organized to execute a processing entity that is configured to execute as a single process or configured to execute using multiple concurrent processes to perform work. A processing entity can be hardware-based (e.g., involving one or more cores) or software-based, and/or can be formed using a combination of hardware and software that implements logic, and/or can carry out computations and/or processing steps using one or more processes and/or one or more tasks and/or one or more threads or any combination thereof.

Some embodiments of a module include instructions that are stored in a memory for execution so as to facilitate operational and/or performance characteristics pertaining to observing and governing the use of infrastructure resources when running self-service Kubernetes workloads. In some embodiments, a module may include one or more state machines and/or combinational logic used to implement or facilitate the operational and/or performance characteristics pertaining to observing and governing the use of infrastructure resources when running self-service Kubernetes workloads.

Various implementations of the data repository comprise storage media organized to hold a series of records or files such that individual records or files are accessed using a name or key (e.g., a primary key or a combination of keys and/or query clauses). Such files or records can be organized into one or more data structures (e.g., data structures used to implement or facilitate aspects of observing and governing the use of infrastructure resources when running self-service Kubernetes workloads). Such files or records can be brought into and/or stored in volatile or non-volatile memory. More specifically, the occurrence and organization of the foregoing files, records, and data structures improve the way that the computer stores and retrieves data in memory, for example, to improve the way data is accessed when the computer is performing operations pertaining to observing and governing the use of infrastructure resources when running self-service Kubernetes workloads, and/or for improving the way data is manipulated when performing computerized operations pertaining to automatically generating executable modules that observe and govern the use of infrastructure resources when running self-service Kubernetes workloads.

Further details regarding general approaches to managing data repositories are described in U.S. Pat. No. 8,601,473 titled “ARCHITECTURE FOR MANAGING I/O AND STORAGE FOR A VIRTUALIZATION ENVIRONMENT” issued on Dec. 3, 2013, which is hereby incorporated by reference in its entirety.

Further details regarding general approaches to managing and maintaining data in data repositories are described in U.S. Pat. No. 8,549,518 titled “METHOD AND SYSTEM FOR IMPLEMENTING A MAINTENANCE SERVICE FOR MANAGING I/O AND STORAGE FOR A VIRTUALIZATION ENVIRONMENT” issued on Oct. 1, 2013, which is hereby incorporated by reference in its entirety.

FIG. 8B depicts a virtualized controller implemented by containerized architecture 8B00. The containerized architecture comprises a collection of interconnected components suitable for implementing embodiments of the present disclosure and/or for use in the herein-described environments. Moreover, the shown containerized architecture 8B00 includes an executable container instance 850 in configuration 8512 that is further described below as pertaining to executable container instance 850. Configuration 8512 includes an operating system layer (the shown OS layer 835) that performs addressing functions such as providing access to external requestors (e.g., user virtual machines or other processes) via an IP address 859 (e.g., “P.Q.R.S”, as shown). Providing access to external requestors can include implementing all or portions of a protocol specification, possibly including the hypertext transport protocol (HTTP or “http:”) and/or possibly handling port-specific functions. In this and other embodiments, external requestors (e.g., user virtual machines or other processes) rely on the aforementioned addressing functions to access a virtualized controller for performing all data storage functions. Furthermore, when data input or output requests are received from a requestor running on a first node are received at the virtualized controller on that first node, then in the event that the requested data is located on a second node, the virtualized controller on the first node accesses the requested data by forwarding the request to the virtualized controller running at the second node. In some cases, a particular input or output request might be forwarded again (e.g., an additional or Nth time) to further nodes. As such, when responding to an input or output request, a first virtualized controller on the first node might communicate with a second virtualized controller on the second node, which second node has access to particular storage devices on the second node or, the virtualized controller on the first node may communicate directly with storage devices on the second node.

An operating system layer (e.g., the shown OS layer 835) can perform port forwarding to any executable container (e.g., executable container instance 850). An executable container instance can be executed by a processor. Runnable portions of an executable container instance sometimes derive from an executable container image, which in turn might include all, or portions of any of, a Java archive repository (JAR) and/or its contents, and/or a script or scripts and/or a directory of scripts, and/or a virtual machine configuration, and may include any dependencies therefrom. In some cases, a configuration within an executable container might include an image comprising a minimum set of runnable code. Contents of larger libraries and/or code or data that would not be accessed during runtime of the executable container instance can be omitted from the larger library to form a smaller library composed of only the code or data that would be accessed during runtime of the executable container instance. In some cases, start-up time for an executable container instance can be much faster than start-up time for a virtual machine instance, at least inasmuch as the executable container image might be much smaller than a corresponding virtual machine instance. Furthermore, start-up time for an executable container instance can be much faster than start-up time for a virtual machine instance, at least inasmuch as the executable container image might have many fewer code and/or data initialization steps to perform than a respective virtual machine instance.

An executable container instance can serve as an instance of an application container or as a controller executable container. Any executable container of any sort can be rooted in a directory system and can be configured to be accessed by file system commands (e.g., “ls”, “dir”, etc.). The executable container might optionally include operating system components 878, however such a separate set of operating system components need not be provided. As an alternative, an executable container can include runnable instance 858, which is built (e.g., through compilation and linking, or just-in-time compilation, etc.) to include any or all of any or all library entries and/or operating system (OS) functions, and/or OS-like functions as may be needed for execution of the runnable instance. In some cases, a runnable instance can be built with a virtual disk configuration manager, any of a variety of data IO management functions, etc. In some cases, a runnable instance includes code for, and access to, container virtual disk controller 876. Such a container virtual disk controller can perform any of the functions that the aforementioned CVM virtual disk controller 826 can perform, yet such a container virtual disk controller does not rely on a hypervisor or any particular host operating system so as to perform its range of functions.

In some environments, multiple executable containers can be collocated and/or can share one or more contexts. For example, multiple executable containers that share access to a virtual disk can be assembled into a pod 817 (e.g., a Kubernetes pod). Pods provide sharing mechanisms (e.g., when multiple executable containers are amalgamated into the scope of a pod) as well as isolation mechanisms (e.g., such that the namespace scope of one pod does not share the namespace scope of another pod). In various implementations a pod represents a set of running or runnable processes. A pod can be deployed as the lowest level executable unit of a containerized application. As used herein, a pod that is instanced within a node can be addressed by a local IP address.

FIG. 8C depicts a virtualized controller implemented by a daemon-assisted containerized architecture 8C00. The containerized architecture comprises a collection of interconnected components suitable for implementing embodiments of the present disclosure and/or for use in the herein-described environments. Moreover, the shown daemon-assisted containerized architecture includes a user executable container instance 870 in configuration 8513 that is further described below as pertaining to user executable container instance 870. Configuration 8513 includes a daemon layer 837 that performs certain functions of an operating system.

User executable container instance 870 comprises any number of user containerized functions (e.g., user containerized function1 860₁, user containerized function2 860₂, . . . , user containerized functionN 860₃). Such user containerized functions can execute autonomously or can be interfaced with or wrapped in a runnable object to create a runnable instance (e.g., runnable instance 858). In some cases, the shown operating system components 878 comprise portions of an operating system, which portions are interfaced with or included in the runnable instance and/or any user containerized functions. In this embodiment of a daemon-assisted containerized architecture, the computing platform 806 might or might not host operating system components other than operating system components 878. More specifically, the shown daemon might or might not host operating system components other than operating system components 878 of user executable container instance 870.

The virtual machine architecture 8A00 of FIG. 8A and/or the containerized architecture 8B00 of FIG. 8B and/or the daemon-assisted containerized architecture 8C00 of FIG. 8C can be used in any combination to implement a distributed platform that contains multiple servers and/or nodes that manage multiple tiers of storage where the tiers of storage might be formed using the shown data repository 831 and/or any forms of network accessible storage. As such, the multiple tiers of storage may include storage that is accessible over communications link 815. Such network accessible storage may include cloud storage or networked storage (NAS) and/or may include all or portions of a storage area network (SAN). Unlike prior approaches, the presently-discussed embodiments permit local storage that is within or directly attached to the server or node to be managed as part of a storage pool. Such local storage can include any combinations of the aforementioned SSDs and/or HDDs and/or RAPMs and/or hybrid disk drives. The address spaces of a plurality of storage devices, including both local storage (e.g., using node-internal storage devices) and any forms of network-accessible storage, are collected to form a storage pool having a contiguous address space.

Significant performance advantages can be gained by allowing the virtualization system to access and utilize local (e.g., node-internal) storage. This is because I/O performance is typically much faster when performing access to local storage as compared to performing access to networked storage or cloud storage. This faster performance for locally attached storage can be increased even further by using certain types of optimized local storage devices such as SSDs or RAPMs, or hybrid HDDs, or other types of high-performance storage devices.

In example embodiments, each storage controller exports one or more block devices or NFS or iSCSI targets that appear as disks to user virtual machines or user executable containers. These disks are virtual since they are implemented by the software running inside the storage controllers. Thus, to the user virtual machines or user executable containers, the storage controllers appear to be exporting a clustered storage appliance that contains some disks. User data (including operating system components) in the user virtual machines resides on these virtual disks.

Any one or more of the aforementioned virtual disks (or “vDisks”) can be structured from any one or more of the storage devices in the storage pool. As used herein, the term “vDisk” refers to a storage abstraction that is exposed by a controller virtual machine or container to be used by another virtual machine or container. In some embodiments, the vDisk is exposed by operation of a storage protocol such as iSCSI or NFS or SMB. In some embodiments, a vDisk is mountable. In some embodiments, a vDisk is mounted as a virtual storage device.

In example embodiments, some or all of the servers or nodes run virtualization software. Such virtualization software might include a hypervisor or corresponding computer modules that manages the interactions between the underlying hardware and user virtual machines or containers that run client software.

Distinct from user virtual machines or user executable containers, a special controller virtual machine or a special controller executable container can be used to manage certain storage and I/O activities. Such a special controller virtual machine is referred to as a “CVM”, or as a controller executable container, or as a service virtual machine (SVM), or as a service executable container, or as a storage controller. In some embodiments, multiple storage controllers are hosted by multiple nodes. Such storage controllers coordinate within a computing system to form a computing cluster.

The storage controllers are not formed as part of specific implementations of hypervisors. Instead, the storage controllers run above hypervisors on the various nodes and work together to form a distributed system that manages all of the storage resources, including the locally attached storage, the networked storage, and the cloud storage. In example embodiments, the storage controllers run as special virtual machines-above the hypervisors-thus, the approach of using such special virtual machines can be used and implemented within any virtual machine architecture. Furthermore, the storage controllers can be used in conjunction with any hypervisor from any virtualization vendor and/or implemented using any combinations or variations of the aforementioned executable containers in conjunction with any host operating system components.

FIG. 8D depicts a distributed virtualization system in a multi-cluster environment 8D00. The shown distributed virtualization system is configured to be used to implement the herein disclosed techniques. Specifically, the distributed virtualization system of FIG. 8D comprises multiple clusters (e.g., cluster 883₁, . . . , cluster 883_{N}) comprising multiple nodes that have multiple tiers of storage in a storage pool. Representative nodes (e.g., node 881₁₁, . . . , node 881_{1M}) and storage pool 890 associated with cluster 883₁ are shown. Each node can be associated with one server, multiple servers, or portions of a server. The nodes can be associated (e.g., logically and/or physically) with the clusters. As shown, the multiple tiers of storage include storage that is accessible through a network 896, such as a networked storage 886 (e.g., a storage area network or SAN, network attached storage or NAS, etc.). The multiple tiers of storage further include instances of local storage (e.g., local storage 891₁₁, . . . , local storage 891_{1M}). For example, the local storage can be within or directly attached to a server and/or appliance associated with the nodes. Such local storage can include solid state drives (SSD 893₁₁, . . . , SSD 893_{1M}), hard disk drives (HDD 894₁₁, . . . , HDD 894_{1M}), and/or other storage devices.

As shown, any of the nodes of the distributed virtualization system can implement one or more user virtualized entities (VEs) such as the virtualized entity (VE) instances shown as VE 888₁₁₁, . . . , VE 888_{11K}, . . . , VE 888_{1M1}, . . . , VE 888_{1MK}, and/or a distributed virtualization system can implement one or more virtualized entities that may be embodied as a virtual machines (VM) and/or as an executable container. The VEs can be characterized as software-based computing “machines” implemented in a container-based or hypervisor-assisted virtualization environment that emulates underlying hardware resources (e.g., CPU, memory, etc.) of the nodes. For example, multiple VMs can operate on one physical machine (e.g., node host computer) running a single host operating system (e.g., host operating system 887₁₁, . . . , host operating system 887_{1M}), while the VMs run multiple applications on various respective guest operating systems. Such flexibility can be facilitated at least in part by a hypervisor (e.g., hypervisor instance 885₁₁, . . . , hypervisor instance 885_{1M}), which hypervisor instances are logically located between the various guest operating systems of the VMs and the host operating system of the physical infrastructure (e.g., node).

As an alternative, executable containers may be implemented at the nodes in an operating system-based virtualization environment or in a containerized virtualization environment. The executable containers comprise groups of processes and/or may use resources (e.g., memory, CPU, disk, etc.) that are isolated from the node host computer and other containers. Such executable containers directly interface with the kernel of the host operating system (e.g., host operating system 887₁₁, . . . , host operating system 887_{1M}) without, in most cases, a hypervisor layer. This lightweight implementation can facilitate efficient distribution of certain software components, such as applications or services (e.g., micro-services). Any node of a distributed virtualization system can implement both a hypervisor-assisted virtualization environment and a container virtualization environment for various purposes. Also, any node of a distributed virtualization system can implement any one or more types of the foregoing virtualized controllers so as to facilitate access to storage pool 890 by the VMs and/or the executable containers.

Multiple instances of such virtualized controllers can coordinate within a cluster to form the distributed storage system 892 which can, among other operations, manage the storage pool 890. This architecture further facilitates efficient scaling in multiple dimensions (e.g., in a dimension of computing power, in a dimension of storage space, in a dimension of network bandwidth, etc.).

A particularly-configured instance of a virtual machine at a given node can be used as a virtualized controller in a hypervisor-assisted virtualization environment to manage storage and I/O (input/output or IO) activities of any number or form of virtualized entities. For example, the virtualized entities at node 881₁₁ can interface with a controller virtual machine (e.g., virtualized controller 882₁₁) through hypervisor instance 885₁₁ to access data of storage pool 890. In such cases, the controller virtual machine is not formed as part of specific implementations of a given hypervisor. Instead, the controller virtual machine can run as a virtual machine above the hypervisor at the various node host computers. When the controller virtual machines run above the hypervisors, varying virtual machine architectures and/or hypervisors can operate with the distributed storage system 892. For example, a hypervisor at one node in the distributed storage system 892 might correspond to software from a first vendor, and a hypervisor at another node in the distributed storage system 892 might correspond to a second software vendor. As another virtualized controller implementation example, executable containers can be used to implement a virtualized controller (e.g., virtualized controller 882_{1M}) in an operating system virtualization environment at a given node. In this case, for example, the virtualized entities at node 881_{1M} can access the storage pool 890 by interfacing with a controller container (e.g., virtualized controller 882_{1M}) through hypervisor instance 885_{1M} and/or the kernel of host operating system 887_{1M}.

In certain embodiments, one or more instances of an agent can be implemented in the distributed storage system 892 to facilitate the herein disclosed techniques. Specifically, agent 88411 can be implemented in the virtualized controller 882₁₁, and agent 884_{1M} can be implemented in the virtualized controller 882_{1M}. Such instances of the virtualized controller can be implemented in any node in any cluster. Actions taken by one or more instances of the virtualized controller can apply to a node (or between nodes), and/or to a cluster (or between clusters), and/or between any resources or subsystems accessible by the virtualized controller or their agents.

Solutions attendant to automatically generating executable modules that observe and govern the use of infrastructure resources when running self-service Kubernetes workloads can be brought to bear through implementation of any one or more of the foregoing techniques. Moreover, any aspect or aspects of maintaining containerized applications on an ongoing basis while staying within the bounds of policy limitations, and in observance of applicable governance rules and regulations, has become impractically burdensome for administrators of containerized data management applications can be implemented in the context of the foregoing environments.

In the foregoing specification, the disclosure has been described with reference to specific embodiments thereof. It will, however, be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are to be regarded in an illustrative sense rather than in a restrictive sense.

What is claimed is:

1. A system for maintaining a Kubernetes cluster on a computing infrastructure, the system comprising:
an application bring-up module configured to deploy a data management application onto the computing infrastructure that hosts the Kubernetes cluster;
a change monitor module configured to (1) receive, from a declarative configuration command interpreter, a desired state of the data management application, and to (2) gather observations of one or more changes that at least potentially affect the desired state of the data management application, and
an update module configured to respond to the one or more changes pertaining to the desired state of a data management application by determining a set of changes to be made to at least one of, the Kubernetes cluster, the data management application, or the computing infrastructure; and
a storage infrastructure on which the Kubernetes cluster is implemented, wherein the storage infrastructure comprises multiple nodes that collectively manage multiple tiers of distributed storage, and wherein the storage infrastructure is instructed to implement the one or more changes corresponding to the desired state of the data management application.

2. The system of claim 1, further comprising an infrastructure discovery module configured to produce one or more resource pools.

3. The system of claim 2, wherein, in response to the one or more, commanding the update module to synthesize a further desired state of a storage infrastructure.

4. The system of claim 3, wherein the further desired state of the storage infrastructure includes use of at least a portion of the one or more resource pools.

5. The system of claim 2, further comprising, commanding the update module to carry out further processing to produce a specification or rule that corresponds to a desired behavior of the data management application.

6. The system of claim 1, wherein the change monitor module makes further observations to identify operations that interact with the Kubernetes cluster during execution of a data management function.

7. The system of claim 1, wherein the change monitor module makes further observations to produce a specification or rule that corresponds to a desired behavior of the data management application.

8. The system of claim 1, wherein the change monitor module makes further observations to identify operations that interact with the Kubernetes cluster during execution of a data management function.

9. The system of claim 1, wherein the declarative configuration is received from a DevOps person as a declarative no-code application configuration that derives from the DevOps person's interaction with a user interface.

10. The system of claim 1, wherein, the one or more changes comprise at least one of, a change to a policy, a change to the data management application, or a change to governance rules.

11. A non-transitory computer readable medium having stored thereon a sequence of instructions which, when stored in memory and executed by a processor cause the processor to perform acts comprising:
invoking an application bring-up module configured to deploy a data management application onto the computing infrastructure that hosts the Kubernetes cluster;
invoking a change monitor module configured to (1) receive, from a declarative configuration command interpreter, a desired state of the data management application, and to (2) gather observations of one or more changes that at least potentially affect the desired state of the data management application, and
invoking an update module configured to respond to the one or more changes pertaining to the desired state of a data management application by determining a set of changes to be made to at least one of, the Kubernetes cluster, the data management application, or the computing infrastructure; and
configuring a storage infrastructure on which the Kubernetes cluster is implemented, wherein the storage infrastructure comprises multiple nodes that collectively manage multiple tiers of distributed storage, and wherein the storage infrastructure is instructed to implement the one or more changes corresponding to the desired state of the data management application.

12. The non-transitory computer readable medium of claim 11, further comprising a sequence of instructions which, when stored in memory and executed by a processor cause the processor to invoke an infrastructure discovery module configured to produce one or more resource pools.

13. The non-transitory computer readable medium of claim 12, wherein, in response to the one or more changes to be made to at least one of, the Kubernetes cluster commanding the update module to synthesize a further desired state of the storage infrastructure.

14. The non-transitory computer readable medium of claim 13, wherein the further desired state of the storage infrastructure includes use of at least a portion of the one or more resource pools.

15. The non-transitory computer readable medium of claim 12, further comprising, a sequence of instructions which, when stored in memory and executed by a processor cause the processor to command the update module to carry out further processing to produce a specification or rule that corresponds to a desired behavior of the data management application.

16. The non-transitory computer readable medium of claim 11, wherein the change monitor module makes further observations to identify operations that interact with the Kubernetes cluster during execution of a data management function.

17. The non-transitory computer readable medium of claim 11, wherein the change monitor module makes further observations to produce a specification or rule that corresponds to a desired behavior of the data management application.

18. The non-transitory computer readable medium of claim 11, wherein the change monitor module makes further observations to identify operations that interact with the Kubernetes cluster during execution of a data management function.

19. The non-transitory computer readable medium of claim 11, wherein the declarative configuration is received from a DevOps person as a declarative no-code application configuration that derives from the DevOps person's interaction with a user interface.

20. The non-transitory computer readable medium of claim 11, wherein, the one or more changes comprise at least one of, a change to a policy, a change to the data management application, or a change to governance rules.
